(19) United States
(12) Patent Application Publication
(10) Pub. No.: US 2013/0216989 A1
(43) Pub. Date: Aug. 22, 2013

(54) PERSONALIZATION PLATFORM FOR BEHAVIORAL CHANGE

(71) Applicant: Melinda Cuthbert, Tiburon, CA (US)

(72) Inventor: Melinda Cuthbert, Tiburon, CA (US)

(73) Assignee: MGOODLIFE, CORP., Tiburon, CA (US)

(21) Appl. No.: 13/772,764

(22) Filed: Feb. 21, 2013

Related U.S. Application Data
(60) Provisional application No. 61/601,895, filed on Feb. 22, 2012.

(51) Int. Cl. G09B 19/00

(52) U.S. Cl. CPC G09B 19/00
USPC 434/238

(57) ABSTRACT

Provided herein is a method and system for supporting behavior-changing decisions. The system solves the challenges encountered in identifying effective personalized behavior-changing recommendations, providing support for behavior-change in real time, and adhering with necessary steps towards an objective. The system can comprise a calendar platform and a messaging platform, thereby providing a user with an array of tools to track, send, and receive information, customized and personalized reminders, participate in a social network, and receive rewards. The system is also capable of building differentiated personalized profiles of antecedants, behaviors and rewards to develop highly targeted treatment indicators and better behavioral outcomes.

### CROSS REFERENCE

This application claims the benefit of U.S. Provisional Application 61/601,895, filed on Feb. 22, 2012, which is incorporated by reference herein in its entirety.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

People looking to change their lifestyle often need guidance on where to begin and how to stay motivated. Exercise, diet, sleep patterns, work balance, studies, and participation in social activities are all lifestyle choices that affect overall health. Understanding what constitutes healthier and better lifestyle choices, and compliance with better options, implicates a series of daily behavioral choices. Information and strategies needed to affect behavior patterns can be difficult to personalize, challenging to follow, and can have a significant impact in an individual's life.

### BRIEF DESCRIPTION OF THE DRAWINGS

FIG. 1 is a network diagram describing the flow of information among users, a subject, a calendar platform, and a messaging platform.

FIG. 2 depicts an illustrative interface by which a user can access a platform for behavioral change through a messaging platform or a calendar platform.

FIG. 3 is a block diagram illustrating a first example architecture of a computer system that can be used in connection with example embodiments of the present invention.

FIG. 4 is a diagram illustrating a computer network that can be used in connection with example embodiments of the present invention.

FIG. 5 is a block diagram illustrating a second example architecture of a computer system that can be used in connection with example embodiments of the present invention.

### SUMMARY OF THE INVENTION

In some embodiments, the invention provides a personalized system comprising: a system for sensing a behavior of a subject in an environment, the system comprising: a) a receiver; b) a first sensor in communication with the receiver, wherein the first sensor is in the environment, and wherein the first sensor detects the behavior and transmits a first signal associated with the behavior to the receiver, whereupon the receiver receives the first signal; c) a second sensor in communication with the receiver, wherein the second sensor is in the environment, and wherein the second sensor detects the behavior and transmits a second signal associated with the behavior to the receiver, whereupon the receiver receives the second signal; and d) a computer system comprising a processor, wherein: 1) the receiver sends the first and second signals to the computer system; and 2) the computer system compares, by the processor, the first and second signals to confirm that the behavior occurred.

In some embodiments, the invention provides a method for detecting an occurrence of a behavior of a subject, the method comprising: a) monitoring the subject with a first sensor to detect the behavior, wherein the first sensor transmits a first signal to a computer system upon detecting the behavior; b) monitoring the subject with a second sensor to detect the behavior, where the second sensor transmits a second signal to the computer system upon detecting the behavior; and c) confirming by the computer system that the behavior occurred by a comparison of the first signal and the second signal, wherein the comparison is performed by a processor.

In some embodiments, the invention comprises a computer program product comprising a computer-readable medium having computer-executable code encoded therein, the computer-executable code adapted to be executed to implement a method for improving a behavior in a subject, the method comprising: a) providing a behavioral change system, wherein the behavioral change system comprises: i) a database, wherein the database comprises behavioral information and recommendations for improving behaviors; ii) a signal detection module; iii) a search module; iv) a behavior interpretation module; and v) a behavioral change output module; b) detecting a signal by the signal detection module, whereupon the signal detection module instructs the search module to search the database for a recommendation for improving the behavior; c) searching the database by the search module, wherein the search module searches the database for the recommendation thereby identifying a potential recommendation for improving the behavior, and transmits the potential recommendation to the behavior interpretation module; d) interpreting the behavior by the behavior interpretation module; wherein the interpreting the behavior comprises associating the behavior with the potential recommendation to identify a relevant recommendation; and e) outputting the relevant recommendation via the output module.

In some embodiments, the invention comprises a system for sensing a factor associated with a behavior of a subject in an environment, the system comprising: a) a first sensor, wherein the first sensor is in the environment, and wherein the first sensor detects a first factor, whereupon the first sensor modifies the first factor, whereupon the first sensor physically transmits a second factor into the environment; b) a second sensor, wherein the second sensor detects the second factor, whereupon detecting the second factor the second sensor transmits an indication that the factor associated with the behavior has been detected.

In some embodiments, the invention comprises a method for detecting a factor associated with an occurrence of a behavior of a subject, the method comprising: a) monitoring the subject with a first sensor to detect the factor associated with the behavior, whereupon the first sensor physically transmits a signal into an environment; and b) monitoring, by at least one additional sensor, the environment for the presence of the signal, whereupon detecting the signal by at least one additional sensor triggers a transmittal of an indication that the behavior has occurred.

### DETAILED DESCRIPTION OF THE INVENTION

The invention addresses a major barrier to improving quality of life, independence, patient engagement with their care, effective delivery of health care, and compliance with specific regimens. People often make decisions towards improving their quality of life and well being, but do not adhere to them. For example, a person can decide to eat less, to exercise regularly, to take classes, or to quit a long-lasting negative habit, but rarely are people able to adhere to such behavior-changing decisions, particularly alone. Moreover, the complexity of case management or coordination of therapies is often left to patients with no medical training. The method of the invention applies social and gaming principles to render behavior-changing decisions entertaining, visual, tangible, engaging and rewarding and to provide support in real-time.

Often times people decide to set their own goals and goals for family members, or physicians, physical therapists, and psychologists advise subjects of the benefits of treatments, self-directed exercises, and therapy sessions. However, lack of comprehension of treatment benefits, busy schedules, the complexity of modern regimens, poor health literacy, the occurrence of undisclosured side effects, and poor communication between a subject and health care providers can all lead to non-compliance with defined objectives. Efforts to improve quality of life and compliance have been aimed at simplifying the language used in the dialogue with a subject, improving patient education, simplifying medication packaging, and providing medication reminders, but those efforts have not improved compliance significantly. The challenges can be just as significant when a subject pursues objectives established alone. Ambiguous goals, poor data interpretation, lack of an appropriate support system, lack of pragmatism, absence of a reward system for milestone achievement, competing priorities, and inadequate scrutiny of a subject's progress all lead to non-compliance and abandonment of important objectives. Furthermore, personalized behavioral change instructions can be provided by ineffective mechanisms, for example, in the form of mail letters and lengthy reading materials, rather than using efficient, real-time, near real-time, or even a present alert. For example, convenient electronic methods MMS messages and calendar reminders can be efficient reminders to the person affected. The system and method of the present invention overcomes such problems by providing the subject with easily accessible and readily absorbed instructions on how to achieve behavior-changing objectives. The efficacy of the invention is improved by the convenience, accessibility, and enjoyment of use.

Provided herein is a system employing principles in behavior and behavioral therapy to support subject compliance with behavior-changing decisions in a real-time context. Types of behavior that can be influenced by the system of the invention include, for example, health, growth and development, independence, parenting, tutoring, teaching, monitoring, coaching, and lifestyle habits. The invention empowers friends, family, and other users to support a user in the pursuit of their goals by providing a system for a user to share information, including objectives and goals.

The present invention relates to a system for sensing a behavior of a subject in an environment, and a method for offering personalized support for behavior changes. In some embodiments, the system comprises a receiver in communication with a first sensor, wherein the first sensor detects the behavior and transmits a first signal associated with the behavior to the receiver. In some embodiments, the system comprises a receiver in communication with a second sensor, wherein the second sensor detects the behavior, and transmits a second signal associated with the behavior to the receiver. In some embodiments, the receiver sends the first and second signals to a computer system comprising a processor. The computer system compares, by the processor, the first and second signals to confirm that the behavior occurred. Communications between users and subjects, the first sensor, the second sensor, the computer system, and the processor can happen according to any communication protocol including, for example, USA, Wi-Fi, Bluetooth, TCP, EnOcean™, WiMax™, ONE-NET, ANT, 6LoWPAN, Wibree, Wireless HART, and IEEE reliant protocols, such as Z-Wave™ and ZigBee™.

Using the system and method disclosed herein, the system can search a database comprising behavioral information for a recommendation for improving the behavior, wherein the search is performed by the processor, and the computer system provides the recommendation to the subject. The system can identify behaviors, and define objectives for behavioral changes. For example, the system can search a database comprising behavioral information for recommendations on smoking cessation. The computer system can provide behavioral changing recommendations to the subject seeking changes on smoking behaviors, for example, increased physical activity, and pursuit of a hobby. The computer system can outline a plan for behavioral change, for example, by populating progress towards objectives within the calendar platform, and reminding the subject hourly, daily, or weekly of achievements, objectives, and progress. The educational content of the present disclosure can be personalized, such that the content is tailored or specific for a subject, or based on a subject's personal information or input. Furthermore, the system can send messages to family, friends, caregivers, and healthcare providers notifying them that a user has authorized them to provide goals and objectives on behalf of a subject. A subject can have access to all recommendation in the database and apply them for present or future behavior changing goals, and a subject can modify those goals at any time.

In some embodiments, the computer system searches a database comprising information that correlates the behavior with a level of acceptability, wherein the search is performed by the processor. The processor can categorize the behavior with a score, wherein the score relates to the acceptability of the behavior, and provides the score to the subject. For example, a subject can receive a low score associated with a persistent smoking habit. A subject can receive a high score associated with progress towards quitting a smoking habit.

### Subjects of the Invention.

Subjects of the invention can be physically, mentally, emotionally, and/or spiritually healthy individuals desirous of change and or improvements in their lives. A subject can be an individual who is not physically, mentally, emotionally, and/or spiritually healthy. For example, a subject can be an individual afflicted by a substance abuse problem, struggling with an unhealthy habit, or seeking self-improvement or goal-realization.

Subjects can be, for example, elderly adults, adults, adolescents, pre-adolescents, children, toddlers, and infants. Users of the system can be custodians of the subject, health care providers, family members, friends, and subjects. Subjects can customize and access personalized interfaces, for example, a messaging platform and a calendar platform, to set goals, monitor progress, receive salient rewards, communicate with health care providers, and reach out to a support system. Users can pursue behavior-changing practices of their own, and can support behavior-changing practices of others. Examples of users of a platform for behavioral change include: a) subjects seeking to change lifestyle habits, for example, smokers, overweight and sedentary subjects; b) patients seeking to comply with a prescribed regimen; c) caretakers helping subjects adhere to prescribed regiments; and d) family members and health care providers seeking to support behavior changing practices of subjects.

In some embodiments, the subject is an animal, wherein the animal is a non-human animal. In some embodiments, the animal is a mammal, a reptile, a bird, an amphibian, or an aquatic animal. In some embodiments, the animal is a mammal. In some embodiments, the animal is a high-value animal. In some embodiments, the animal is a pet, a guardian, a livestock, a service animal, a show animal, a working animal, a racing animal, or a breeding animal. The systems and methods of the invention can be applied to the health and behavioral monitoring of other animals equally as effectively as to humans.

In some embodiments, the animal is in need of healthcare or behavioral observation or the animal's owner is in want of healthcare or behavioral observation for the animal. For example, a system and a method of the invention can be used to monitor the behavior of a guide dog. Guide dogs can be dogs that help guide blind or visually impaired people.

A subject of the invention can be anyone seeking to change one or a plurality of lifestyle habits. A subject of the invention can be anyone seeking to adhere to lifestyle changing habits. A subject of the invention can be anyone prescribed a regimen of lifestyle changing habits. A subject of the invention can be, for example, anyone seeking to change dietary habits, to give-up addictions, to participate in a rehabilitation program, to adhere to a prescribed medical regimen, or to achieve one or a plurality of objectives. A subject can be someone in need of monitoring by a custodian, guardian, or caretaker, such as an autistic child. A subject can be an individual in a situation that requires monitoring, such as an individual monitored within a detention center, a prison system, or a reformatory establishment.

A subject of the invention can be an elderly person living on their own, a subject can be a person with an executive function disorder who requires more structure and priority setting in their day. A subject might be a person with a mood disorder who can benefit from sensor feedback of escalating agitation. A subject can receive recommendations via the Messaging Platform or the Calendar Platform of the invention to remediate their escalation. A subject can be congratulated the subject's success in remediating the escalation of a behavior. The subject can receive a reward for their progress.

A subject can be anyone who has had a medical encounter. A medical encounter can be a situation in which a subject divulges medical information to a medical worker, for example, a clinician, a doctor, a physician, a nurse practitioner, a hospital worker, a specialist or a physician assistant. A medical encounter can provide medical information such as: a complaint related to the nature and duration of a condition; the history of the subject's condition at the time of the medical encounter; a recitation of symptoms that a subject is experiencing; physical examination comprising one or more observations of the subject; vital signs and status of organs; muscle power; and/or diagnosis and recommendations for treatment.

A system of the invention can support any number of users, who can be, for example, physicians, clinicians, patients, caregivers, attendants, and researchers. A user can browse a list of subjects served by, for example, a certain healthcare or research facility. The user can add new subjects, edit the objectives of the existing subjects, or delete old subjects, as is appropriate for maintaining accurate clinical and research records in accordance with the prevailing regulations. A user can build a behavior-changing regimen for a subject using a system of the invention. A regimen, broadly, encompasses the recommendations and objectives for a subject.

The system of the invention can also accommodate multiple users, and users can have permission to monitor multiple subjects. For example, a physician can use the system of the invention to set objectives and monitor progress of a plurality of patients. A patient can be monitored by multiple users, for example, a physician and a physical therapist. A lawyer can set goals for the lawyer's clients, and monitor the client's progress towards the client's goals, set alerts and provide coaching when the student requires it. A teacher can set goals for the teacher's students, and monitor the student's progress towards the student's goals, set alerts and provide coaching when the student requires it. The system of the invention can also set objectives, and monitor goals for groups of subjects, for example, sports teams, an educational cohort, family members, research cohorts, people engaged in a particular treatment, at-risk populations, social, religious, and cultural groups, employee groups, and/or groups of patients.

### Systems of the Invention.

The system of the invention comprises a personalized support application for behavioral change. The system and method of the invention can improve health, learning, growth, development, independence, and lifestyle habits. The system combines the use of personalized data retrieved from a plurality of databases, and data retrieved from a subject in an environment to provide personalized objectives, and recommendations on actionable items that can be pursued to achieve or make progress towards an objective.

In some embodiments, the system for sensing a behavior of a subject in an environment comprises a receiver. In some embodiments, the receiver is in communication with a plurality of sensors, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 sensors present in the environment. As the subject engages in a behavior the receiver sends the signals to a computer system comprising a processor, wherein the computer system compares, by the processor, the first and/or second signal(s) to confirm that the behavior occurred. For example, the receiver can receive information from a pedometer (sensor) in a subject's shoes. As the subject walks, the pedometer communicates the number of steps walked to a receiver. A computer processor processes the signal and confirms the number of steps walked by a subject.

In some embodiments, the method for detecting an occurrence of a behavior of a subject comprises a method wherein the subject is monitored with a first and/or a second sensor(s), wherein the first and/or second sensor(s) transmit a first and/or second signal(s) to a computer system upon detecting the behavior, and wherein the signal comparison is performed by a processor. The first and the second sensors can be of the same or different types. For example, a first sensor can be present in or on a subject's person, and a second sensor(s) can be present in any of a plurality of appliances within the subject's home.

In some embodiments, the relationship between the first and second sensor is spatial. For example, sensors can act cooperatively based on relative size, shape, position, location, and depth. For example, a first sensor can be a motion detector associated with a subject's kitchen, and have a spatial relationship to a second motion detector sensor associated with a subject's dining room.

In some embodiments the relationship between the first and second sensor is functional. For example, one sensor can have the same purpose, practicality, serviceability, usefulness, and utility as the other sensor. A first sensor can be a motion detector associated with a subject's kitchen, and the first sensor can have a functional relationship to a second motion detector associated with a subject's person in that both are useful for monitoring eating habits. The first and the second sensors can be physically and structurally different, but share common functionalities and purposes.

In some embodiments, the relationship between the first and the second sensor is that one provides spatial data and the other provides functional data. A first sensor can, for example, be a motion detector located within a clothing pin on a subject's person, and a second sensor can be a microwave radiometer associated with a subject's microwave appliance. The first and the second sensors do not behave similarly, but act as the first and as the second sensor within the system of the invention. In some embodiments, a first sensor can adjust a response accordingly to a signal received by a second sensor. In some embodiments, a second sensor can adjust a response accordingly to a signal received by a first sensor.

In some embodiments, a subject can directly transmit the type of behavior to a system of the invention. For example, a subject can access a messaging or a calendar platform of the invention and a subject can identify that a behavior has occurred by inputting information in the messaging or the calendar platforms of the invention. In this example, the subject sends a first signal message or calendar input to a computer system. In some embodiments, a computer system can compare, by a processor, the association of a first signal directly inputted by the subject to a second signal detected from the environment in order to confirm that a behavior occurred. Systematic data entry pages can be generated in real-time, allowing a steady collection of the data.

The system of the invention can work with a plurality of different sensors. Non-limiting examples of categories of sensors are: a) acoustic sensors, detecting sound and vibration; b) motion sensors; c) proximity sensors; d) optical, light, imaging, and photon sensors; e) pressure sensors; f) thermal sensors; g) magnetic sensors; h) environment sensors, detecting weather, moisture, and humidity; i) chemical sensors; and j) biological sensors.

Non-limiting examples of sensors include microphones, seismometers, geophones, hydrophones, guitar pickups, speed sensors, radars, parking sensors, gps sensors, motion detectors, alarm sensors, touch switches, infrared sensors, proximity sensors, occupancy sensors, Doppler radars, contact image sensors, electro-optical sensors, charge-coupled devices, colorimeters, flame detectors, kinetic inductance detectors, LED sensors, LED as light sensors, light-addressable potentiometric sensors, Nichols radiometers, fiber optic sensors, optical position sensors, photodetectors, phototransistors, photoelectric sensors, superconducting nanowire single-photon detectors, visible light photon counters, wavefront sensors, barographs and barometers, galvanometers, Hall effect sensors, leaf electroscopes, magnetic anomaly detectors, magnetometers, MEMS magnetic field sensors, metal detectors, radio direction finders, voltage detector calorimeters, exhaust gas temperature gauges, gardon gauges, golay cells, heat flux sensors, thermometers, infrared thermometers, microbolometers, microwave radiometers, net radiometers, quartz thermometers, resistance temperature detectors, resistance thermometers, silicon bandgap temperature sensors, special sensor microwave/imagers, bedwetting alarms, ceilometers, dew warning sensors, electrochemical gas sensors, gas detectors, hook gauge evaporimeters, humistors, hygrometers, leaf sensors, pyranometers, pyrgeometers, psychrometers, rain gauges, rain sensors, snow gauges, soil moisture sensors, stream gauges, tide gauges, breathalyzers, heartbeat sensors, carbon dioxide sensors, carbon monoxide detectors, catalytic bead sensors, chemical field-effect transistors, electrochemical gas sensors, electronic noses, electrolyte-insulator-semiconductor sensors, fluorescent chloride sensors, holographic sensors, hydrocarbon dew point analyzers, hydrogen sensors, hydrogen sulfide sensors, ion-selective electrodes, microwave chemistry sensors, nitrogen oxide sensors, olfactometers, optodes, oxygen sensors, pellistors, pH glass electrodes, potentiometric sensors, redox electrodes, smoke detectors, zinc oxide nanorod sensors, and biosensors. Sensors can be wirelessly readable.

A biosensor can be a sensor capable of sensing a biological molecule or a biological motif. Non-limiting examples of biomolecules include amino acids, antibodies (monoclonal or polyclonal), antibody fragments, antigens, epitopes, carbohydrates, lipids, fatty acids, enzymes, factors, natural products, nucleic acids, including DNA and RNA, nucleosides, nucleotides, structure analogs or combinations thereof, nutrients, peptides, peptide-mimetics, proteins, recombinant proteins, receptors, vitamins, and combinations thereof. A biosensor can be used to detect the levels of a biological molecule or a biological motif.

A biosensor can be comprised within a swallowable pill or capsule. A biosensor can be an implantable, ingestible, or wearable, sensor. A biosensor can be wirelessly readable. A biosensor can, for example, be comprised within a polymer, a biocompatible material, or a suitable semi-permeable membrane. A biosensor can be implanted in a subject, for example, in the mouth, larynx, blood vessel, vein, nose, ear, eye, heart, brain, lymph node, lung, breast, stomach, pancreas, kidney, colon, rectum, ovary, uterus, bladder, prostate, skin, or fingernail. A biosensor can report a physiological condition in real-time.

A sensor can have a plurality of components. A sensor can communicate with other sensor and/or components using electrical, electronic, or electromagnetic signals, for example, optical, radio frequency, digital, analog, chemical, biological, and a plurality of other signaling methods.

Another aspect of the present invention relates to a method for applying geolocation data from a plurality of devices including phones, tablets, and sensors that can personalize lifestyle recommendations to where a user is present in real time. In some embodiments, the subject can have a first sensor associated with the subject's body. A non-limiting example of a first sensor associated with the subject's body is a mobile device on a subject's person. In some embodiments, a first sensor is worn on the subject's body or clothing. For example, a sensor can be worn as an accessory or as a clothing pin. In some embodiments, the first sensor is suitable for ingestion into the subject's body. For example, the first sensor can be an ingestible monitoring device. In some embodiments, the first sensor can be implanted into the subject's body. For example, the first sensor can be a subcutaneous sensor implanted under the skin. The objective engine of the systems of the invention can auto-populate goal recommendations and objectives for a subject based on geolocation data.

The objective engine of the systems of the invention can auto-populate goal recommendations based on a plurality of data acquired from a plurality of sensors. For example, a sensor of the invention can detect increased temperature in a subject's wound from a sensor placed in the subject's skin. A system of the invention can auto-populate a goal with recommendations to reduce the temperature in a subject's wound. The system of the invention can send a message through the Message Platform to health care personnel, thereby alerting health care personnel of a sensed activity relating to the subject. The system of the invention can schedule an appointment with a qualified health care provider, such as a physician, nurse, or a nurse practitioner. The system of the invention can communicate with a pharmacy through the Message Platform of the invention, and the system of the invention can be used to place an order, for example, of an antibiotic cream that can be applied to the suture.

In some embodiments, the system of the invention can detect that an environment is the subject's home. For example, the system of the invention can use geolocation data to determine that a subject sporadically leaves the subject's home. The method of the invention can set behavior-changing objectives in the objective engine seeking, for example, a positive change in a sedentary lifestyle. The subject can acknowledge the behavior and set behavioral changing objectives in the objective engine, seeking, for example, a positive change in a sedentary lifestyle. The system of the invention searches a database comprising behavioral information for a recommendation for improving the behavior, and provides the recommendation to the subject. The system of the invention also can, for example, auto-populate personalized behavior-changing objectives within the objective engine, personalizing a regimen that supports a change in the subject's sedentary life style. For example, the system can auto-populate goals that comprise a motivational system. The invention can compare the success of a subject, or a plurality of subjects, in achieving such motivational goals. The invention can auto-populate a recommendation towards achieving a goal based on the number of subject's that have successfully applied the recommendation towards achieving the goal. The invention can auto-remove a recommendation towards achieving a goal based on the number of subject's that have failed to apply a specific recommendation towards achieving a goal. The invention can auto-populate, and the invention can auto-remove, a goal based on a subject's behavior.

Another aspect of the invention relates to a method for correlating self-reported subject input to the behavior sensed by the sensors. For example, the system and method of the invention can identify that a behavior has occurred as sensed by the sensors. The behavior detected by the sensors can be compared to self-reported subject input to validate that input, to determine a historical trend of accuracy, and to find correlations that help identify false positives. The behavior detected by the sensors can be compared to self-reported subject input to identify an association of a biometric marker with the behavior. The behavior detected by the sensors can be compared to self-reported subject input to identify a previously uncharacterized aspect of the behavior. For example, a parent monitoring an autistic child can identify a previously uncharacterized, unknown, or unpublished aspect of autism.

### Database.

The system and method of the invention can use data from multiple databases to help users and subjects set relevant objectives, to set objectives for subjects, to monitor progress towards objectives, and to help subjects achieve salient rewards, while providing a rich personalized experience. The system and method of the invention can mine data detected by a plurality of sensors, from a plurality of devices, and from a plurality of databases. The invention can use the collected and/or combined data to provide objectives, and post progress towards objectives.

Databases can comprise a plurality of collections of data, including, for example, health, bibliographical, physical, emotional, and spiritual data. Databases can comprise data within health management platforms, for example, mHealth™, electronic medical records, research and care delivery organizations, pharmaceutical, and health insurance databases. Databases can be organized within a plurality of data management systems, for example, Microsoft Access™, Microsoft™ SQL Server, Oracle™, and IBM™ DB2.

The system of the invention can retrieve data from a plurality of different databases, supported by a plurality of different data management systems, including, for example: a) graph databases, wherein the database uses graph structures with nodes, edges, and properties to represent and store information; b) hypermedia databases, wherein the web-based information can be a database; c) hypertext databases, wherein any word or piece of text representing an object can comprise a database, for example, a medical encyclopedia; d) in-memory database, wherein the database resides primarily in memory, for example, within a sensor's memory; e) document-oriented databases, wherein the database stores, retrieves, and manages document-oriented, or semi-structured data, for example, a subject's medical history can be accessed by the system of the invention from a document-oriented database; f) cloud databases, wherein the database and a data management system reside remotely; g) data warehouses, wherein the data warehouses archive data from operational databases and data can undergo transformation on their way into the warehouse, getting summarized, and reclassified, for example, weight loss data can be aggregated to a weekly total, and converted from daily weight measurements to weekly, monthly or yearly weight losses; h) active databases, wherein the database can respond to conditions both inside and outside the database in real-time, for example, an active database can detect the occurrence of a behavior by a sensor in real-time; i) distributed databases, wherein the database includes a plurality of modules that can include modules shared by multiple sites, and modules specific to one site and used only locally in that site, for example a database used and shared by local medical-groups, departments at regional hospitals, branch hospitals, and other hospital management locations; j) embedded databases, wherein the database is a database management system which is tightly integrated with application software that requires access to stored data in a way that the database management system is hidden from the application's end-user, for example, the invention can access medical records from a medical records platform that is a database management system; k) end-user databases, wherein the end-user database consists of data developed by individual end-users, examples of these are collections of documents, spreadsheets, presentations, multimedia, and other files developed by the subject; 1) federated databases and multi-databases, wherein a federated database is an integrated database that comprises several distinct databases, each with its own data management system; m) knowledge-based databases, wherein the database provides the tools for the computerized collection, organization, and retrieval of knowledge, for example, data representing collections of problems and related experiences; n) operational databases, wherein the database process relatively high volumes of updates using detected behavior; o) spatial databases, wherein the database can store data with multidimensional features; p) temporal databases, wherein the database includes built-in time aspects, examples include a valid-time and behavior occurrence-time; q) unstructured-database, wherein the database is constructed to store in a manageable and protected way diverse objects that do not fit naturally and conveniently in common databases, including for example email messages, documents, journals, and multimedia objects.

The system of the invention can collect data from a plurality of individuals and organizations, for example: hospitals, clinics, primary care centers, hospices, convalescent homes, outpatient facilities, health care providers, electronic health records (EHRs), pharmaceutical companies, health insurance companies, research institutions, care delivery organizations, individual practitioners, and subjects. The system of the invention can use the collected data to assist in providing personalized objectives for a subject. In some embodiments, a system of the invention searches a database comprising information for a recommendation for improving the behavior. For example, a health care provider can recommend a target weight loss for a subject. The system of the invention can search a database and provide dietary recommendations that can help the subject achieve a weight loss goal. Recommendations can be displayed to the user in the message platform and in the calendar platform of the invention. Recommendations can be modified, accepted, or rejected by a user. A subject can consent to delegate oversight of goals and recommendations to a user.

In some embodiments, the system of the invention can collect data from the subject for entry into a database. A subject can enter the messaging platform, and the calendar platform within the objective engine, which can be operable to track a subject's nutrition, exercise effort, and stress levels. The subject can enter a plurality of data points within the system of the invention including quantitative data points, for example, biometrics such as height and weight, and qualitative data points, such as sadness and happiness levels. The collective information can be used to produce a data entry in a database for future searching and reference. A plurality of subject's and user's can produce a plurality of entries in a database for future searching and reference.

In some embodiments, the method for identifying the behavior further comprises searching by the computer system in a database comprising behavioral information for a recommendation for improving the behavior, wherein the computer system performs the search by a processor, and provides the recommendation to the subject.

The system of the invention provides a platform for behavioral databases that can communicate with a plurality of electronic devices that can be used by health care providers or subjects. The health care providers can be employed by or associated with a subject. In some embodiments, the data collected can correspond to electronic medical records.

In some embodiments, the system of the invention can collect personal health information for entry into a database. Personal health information of a subject can comprise general information about the subject, medical history, medical encounter history, existing disease information, and pertinent information regarding recent activities. Non-limiting examples of personal health information include, age, sex, blood type, family history, height, weight, diet, BMI, risk for diabetes mellitus (DM) and pre-DM, family history, risk for pre-hypertension (HTN), systolic and diastolic blood pressure measurements, salt intake, microscopic urinalysis, proteinuria, serum blood urea nitrogen, creatinine levels, calcium levels, thyroid-stimulating hormone (TSH) levels, blood glucose, HDL and LDL cholesterol levels, triglycerides, hematocrits, electrocardiograms, and/or chest radiographs, metabolic syndrome, hyperlipidemia, risk of infection, decreased immune system, compromised circulation, compromised skin integrity, repeated contact with contagious agents, cancer screening, CAT scans, and MRIs.

In some embodiments, the system of the invention can collect pertinent information regarding subject behavioral activities including: a) psychological parameters, for example, anxiety, depression, psychosocial crisis, suicidal ideation, and/or stress levels; b) physical parameters, for example, nutritional intake, and exercise extent; and c) a plurality of qualitative and quantitative parameters, for example, social engagement, mood, affectiveness, motivation, and commitment levels. The system of the invention can combine knowledge of personal health information with consistent behavioral patterns to help a subject identify personalized behavior-changing objectives. For example, the system of the invention can use medical information describing a subject's history of anxiety and high stress levels to provide objectives and recommendations towards reducing anxiety and stress levels, such as getting a minimum of seven hours of sleep a night, maintaining healthy eating habits, participating in physical recreational activities, limiting intake of alcohol, and scheduling regular psychotherapy sessions, and medical checkups.

### Recommendations.

Determining personalized behavior-changing recommendations, and objectives, can depend on subject characteristics. Subject characteristics broadly encompass information describing a subject of interest to a user of a device of the invention, the subject being a human, for example, a patient or relative, associate, or representative thereof. A subject characteristic can be any information that describes the general status of a subject, such as a patient. Non-limiting examples of subject characteristics include: clinical values; demographic information; personal information such as, name, date of birth, date of admission, date of discharge, etc.; indications; past indications; prescriptions; medical orders; and genetic and genomic information, such as a genetic signature, a gene, an allele, a genotype, a phenotype, a mutation, a polymorphism, a genetic function, or a pathway.

In some embodiments, the system of the invention can provide the subject with morbidity and mortality data associated with certain types of behaviors.

In some embodiments, the system of the invention can use the frequency, duration, seriousness, and basis of current and past behaviors for behavior to identify antecedents, forecast behavior-changing and function-changing objective consequences, and provide behavior-changing and function-changing objectives. For example a subject with a history of non-compliance with prescribed medical regimens can seek a behavior-changing objective to comply with a low cholesterol regimen. A first sensor within the subject's person can sense the levels of cholesterol consumed by the subject. The system of the invention can search a database and provide recommendations of meals with low cholesterol content that can help the subject adhere to the objective. A second motion sensor within the subject's kitchen can send recommendation reminders whenever upon detecting that the subject has approached a refrigerator, a pantry, or a food storage location. The system of the invention can use the frequency of the subject's presence in the kitchen and/or the duration of the subject's presence in the kitchen to identify appropriate recommendations of food for consumptions, for example, snacks or meals. Such data can be triangulated with data from an electronic food inventory system that identifies available food in the fridge, notes the nutritional content of that food, and makes recommendations regarding types, and quantities, of foods that can be consumed and support progress towards a goal. The invention also provides a system, via the Messaging and Calendar platforms to support the order of recommended food types.

In some embodiments, a geolocation sensor(s) allows the system to monitor the subject's location within the subject's home, while a plurality of other sensors monitor the use of various home appliances and devices to detect the occurrence of behaviors. For example, a system of the invention can be used to monitor a subject's eating habits within the subject's home. The subject wears a global positioning sensor, which is in communication with a receiver, and the system can determine the geographic location of a subject whilst other sensors can monitor, for example, how many times the subject has opened the refrigerator door, and how often the subject has walked to the kitchen. For example, the system of the invention can make both personalized and geospecific recommendations to a subject seeking to avoid consuming tobacco products, such as, for example, if the subject smokes after eating, the system of the invention can recommend walking a particular path after a meal, or driving to a nearby story to purchase a substitute to tobacco, such as chewing gum.

Another aspect of the present invention relates to a method for providing behavior-changing objectives based on factual behavioral data. In some embodiments, a second sensor is not associated with the subject's body. For example, a second sensor can be a household appliance, such as a refrigerator, or a second sensor can be associated with a household appliance, such as a refrigerator. The system of the invention can determine a subject's behavior, for example, how often a subject opens the door of the refrigerator within the subject's home. Upon detecting the behavior, the system of the invention can process the subject's behavioral data and provide behavior-changing recommendations to the subject as objectives in the calendar platform and/or in the messaging platform.

In some embodiments, the subject is unaware of the behavior. For example, a parent can use a microphone sensor to monitor the use of foul language by a child throughout the day. The microphone sensor can, for example, populate the calendar platform with occurrences of foul language use by the child, listing time of occurrence and frequency of occurrence. The child can be unaware of the behavior. The parent can use the message platform to communicate with the child. The invention can provide incentives for the child to avoid foul language, including, for example, a movie ticket reward.

A parent can, for example, use a moisture sensor in a toddler's diaper to guide the process of toilet training the toddler. The moisture sensor can, for example, provide a voice message that reminds the toddler to use the toilet. A second sensor in a toilet can, for example, detect if the toddler has, in fact used the toilet. The invention can populate real-time messages in the message platform alerting a parent that the child has used the toilet. A parent can, for example, congratulate the toddler on using the toilet and provide a positive feedback system.

An anorexic subject can, for example, have a biosensor implanted in the subject's stomach. A first biosensor can detect the levels of bile in the stomach. A second biosensor and a third biosensor can detect the overall presence of proteins and lipids in the stomach, indicating the overall presence of food in the stomach. Upon detecting an established threshold level of bile, a biosensor can, for example, send a message to the message platform of the anorexic subject with food intake recommendations.

The recommendations can include suggestions of types and amounts of food for consumption.

### Objective Engine and Personalized Objectives.

Personalized objectives can comprise a plurality of segments, each segment represented as objective milestones, objective goals, daily objectives, partial objectives, monthly objectives, and yearly objectives. A customized script can be utilized to concatenate two or more objectives, such as objectives 3, 4, 5, 6, 7, 8, 9, 10 or more objectives to generate personalized content based on a subject's behavior. The messaging module of the computer system of the personalized platform for behavioral change is operable to communicate and exchange behavior education content, personal communication between subjects and users, and subject health information from one or more storage modules within the computer system.

Personalized objectives can be quantitative or qualitative in nature. A subject can be provided with a list of recommendations along with a list of objectives. In some embodiments, the occurrence of a behavior of a subject can be used to adjust personalized objectives. For example, a subject can seek to comply with qualitative spiritual objectives, such as complying with the values and doctrines of a particular faith, and/or a subject can seek to comply with quantitative spiritual objectives, such as participating in a defined number of religious events in a given month.

The system and method for behavioral change can be operable to analyze the health information of a subject based on a subject's objectives, provide personalized health education for a subject based on a subject's objectives, provide personalized reminders to a subject based on a subject's objectives, and provide one or more points redeemable for one or more reward credits incentivizing a subject's achieving or making progress towards a target objective. The present invention links personalized health education with reminders, rewards, and incentives that can motivate subject behavior, and increase adherence and compliance. The objective-based health education, health reminders, and reward credits can help subject populations achieve a higher degree of compliance with medically prescribed behavioral change regimens.

The messaging and the calendar platforms are operable to support subject health information exchange, personal communication between subjects and users, including health care providers, and behavior education content. The message and calendar platforms can support communication and reminders with written, video, and audio content. The message and calendar platforms can be associated with timestamps. A timestamp can indicate a point in time wherein an objective was written and made available to a subject. Pictures or videos can be timestamped and correlated with the goals for people who are nonverbal or cognitively challenged. For example, a health care provider can recommend a change in diet to a subject, and the subject can see the date and time when the recommendation was made. The messaging and the calendar platforms can also support case management, coordination of activities between a plurality of users, an dprioritization of tasks and goals.

Content within the objective engine can be tagged by users and subjects for a subject to view. For example, a health care professional, such as a therapist, can tag a written, video, or audio message within the objective engine for the subject to review. The message can be, for example, a reminder of an upcoming appointment, or a follow up on the adherence to a regimen of behavioral changing decisions. The subject can view tags and information within the calendar and message platforms.

In some embodiments, after receiving one or more messages from a user, such as one or more text messages from a physician, therapist, or family member, a subject can reply or respond to the user sending the message with a question. A response from a physician can be forwarded to a subject from a plurality of different devices. In some embodiments, the body of the original message can be included in the forwarded message, for example, so a user knows, or is reminded, of the context in which a question is being asked.

In some embodiments, the system disclosed herein can comprise a behavioral change reminder system. The behavioral change reminder system can be subject-based, user-based, or both subject-based and user-based. The reminders can comprise one or more tiers, for example, a first reminder can make a subject aware of recommendations a subject should follow within the period of a week to achieve a target milestone. A second reminder can make a subject aware of the recommendations he needs to follow within the next twenty-four hours to be on target for achieving a target milestone. In some embodiments, the disclosed reminder system can help improve the overall quality of a subject's health, by providing safe, convenient, efficient, and timely objective reminders. The reminder system can help increase behavioral change compliance.

In some embodiments, the system disclosed herein can comprise a behavior interpretation system. The behavior interpretation system can associate the behavior with potential recommendations. For example, a user can specify an objective within the objective engine of losing a specified amount of weight. The invention can monitor the subject's habits within the subject's home. The subjects can wear a geolocation sensor that allows the system to monitor the subject's location within the subject's home. Other sensors can monitor the use of various appliances and devices, such as the subject's refrigerator, freezer, kitchen cabinets, cupboards, and other food-storage locations, which are each equipped with an electromagnetic sensor, which detects that the food-storage locations has been opened and closed. The system notes when a food-storage location is accessed while the global positioning sensor is within a reasonable distance of the food-storage location. The system can interpret the behavior as an indication that the subject has been eating, and the system can identify and provide relevant recommendations, for example, the system can suggest healthy meal options or the system can suggest a minimum period of time between meals.

In some embodiments, interpreting the behavior creates a medical record data point. For example, a subject can use the system of the invention to monitor a subject's sleeping patterns. The subject can wear a heartbeat sensor that allows the system to monitor the heart rate throughout the day, including during the hours of uninterrupted unconscious sleep, when the heart-rate can go down by 10-30 heartbeats a minute. Monitoring and interpreting a subject's heart rate throughout a specified period of time can create a medical record data point.

In some embodiments, the system and method of the invention can identify a previously uncharacterized aspect of a behavior. Monitoring and interpreting a subject's heart rate throughout a specified period of time can reveal, for example, previously uncharacterized associations between heart-rate levels and insomnia.

In some embodiments, the system of the invention can develop standardized measures for detecting biometrics. Sensing a specific biometric can lead to the association of new biomarkers with a behavior or a condition. For example, a subject can wear an ingestible sensor that is sensing the breakdown of a metabolite within the subject's stomach. The system of the invention can associate the sensing of the metabolite with for example, the subject's increased urge to urinate. In this example, the system of the invention can identify the metabolite as a diuretic biomarker.

### Calendar and Reminder.

The system of the invention comprises of an objective engine interface, wherein a subject and/or an authorized user can access a messaging platform and a calendar platform to determine objectives, monitor progress, and communicate with a plurality of users and data sources. A messaging platform within the objective engine can be configured by a user or a subject from a plurality of available systems for social messaging. Messages can consist, for example, of objective reminders, instructions towards an object progress/completion, and/or support messages. Types of messages can include, for example, text messages, audio messages, or video messages. The frequency at which any of the messages described herein are sent can be determined by the subject or a user, for example, a family member, a therapist, or a physician. A therapist can, for example, denote to send subjects messages containing guidelines towards objective achievement once or twice every day, week, or month. The frequency at which messages are sent to a subject can also be adjusted by the subject. A calendar platform within the objective engine can be configured by a user or a subject from a plurality of available systems for objective schedule monitoring and tracking The calendar platform also provides access to fields pertaining to objective(s), reward(s), message(s), progress bar(s), and history. For example, a subject seeking quitting consuming tobacco products can set a date to quit in the calendar platform, and receive information and communication pertaining to the objective in the messaging platform.

Subject input of pertinent information regarding recent activities can initiate one or more further reminders for health-related activities, for example, exercise, dieting, or check-ups. In some embodiments, a subject's activities can include activities associated with a wellness program, for example, mental, physical, and spiritual activities of the wellness program. In some embodiments, reminders can be set to be delivered on a time frame desired, specified, or requested by the subject. In some embodiments, the desired time can be, for example, hourly, daily, weekly, monthly, and/or yearly. In some embodiments, reminders can be set to be delivered hourly, for example, once every 1, 2, 3, 4, 5, 6, 7, 8, 9, 10, 11, 12, 13, 14, 15, 16, 17, 18, 19, 20, 21, 22, 23, or 24 hours. In some embodiments, reminders can be set to be delivered daily, for example, once every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or 31 days. In some embodiments, reminders can be set to be delivered weekly, for example, once every 1, 2, 3, or 4 weeks. In some embodiments, reminders can be set to be delivered monthly, for example, once every 1, 2, 3, 4, 5, 6, 7, 8, 9, 10, 11, or 12 months. In some embodiments, reminders can be set to be delivered yearly, for example, once every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 years.

An indication that a behavior has occurred can be a reminder. An indication that a behavior has occurred can be for example, a sound made by a sensor, such as a beeping sound, a change of color by a sensor, an odor transmitted by a sensor, a visual cue transmitted by a sensor, a flavor transmitted by a sensor, or a physical sensation transmitted by a sensor, such as a vibration.

### Goal Determination.

To determine meaningful, appropriate, realistic, and effective goals and objectives, the system of the invention can use the combination of data detected by the sensors from the environment, with the subject's input, input from friends and family, personal medical records, and/or personal history.

A subject's personal history can refer to a medical record of what has happened to the subject since birth. For example, personal history can be a record of diseases, major and minor illnesses, and/or growth landmarks. In some embodiments, medical history can comprise surgical history. Surgical history can describe surgery performed on a subject, for example, dates of operations, operative reports, and/or the detailed narrative of what a surgeon performed.

In some embodiments, medical history can comprise obstetric history. Obstetric history can comprise prior pregnancies, pregnancy outcomes, and/or pregnancy complications. In some embodiments, medical history can comprise medications and medical allergies, for example, a subject's current and previous medications and/or medical allergies.

In some embodiments, medical history can comprise family history. Family history can comprise one or more lists of immediate family members' health status, for example, causes of death, diseases common in the subject's family or found only in one sex or the other, and/or a pedigree chart.

In some embodiments, medical history can comprise social history. Social history can comprise one or more chronicles of a subject's human interactions, for example, relationships of the subject, a subject's careers, trainings, schooling, religious training, and/or progress on educational or career goals. In some embodiments, social history can provide information regarding community relationship support that the subject can expect for a particular disease, provide information that can explain one or more behaviors of a subject in relation to one or more illnesses or losses, and/or can provide information to aid in a determination of one or more causes of one or more illnesses, for example, occupational exposure to asbestos. In some embodiments, medical history can comprise habits which can impact a subject's health. Habits which impact health can comprise, for example, tobacco use, alcohol intake, exercise, diet, sexual habits, and/or sexual orientation. In some embodiments, medical history can comprise immunization history. Immunization history can comprise a history of a subject's vaccinations, and/or blood tests providing immunity data.

In some embodiments, medical history can comprise one or more growth charts and developmental history. For example, if the subject is a child or teenager, growth charts and developmental history can comprise one or more charts documenting a subject's growth and/or a comparison to data of other subjects of the same age. In some embodiments, growth charts and developmental history can provide information for the cause of an illness because many diseases and social stresses can affect growth and development of a subject. In some embodiments, growth charts and developmental history can comprise information regarding a child's behavior, for example, timing of talking, and/or timing of walking, and/or a comparison to other children of the same age.

Pharmacy medical records (PMR) can relate to records pertaining to a subject's pharmacological history. In some embodiments, pharmacological history can comprise a subject's prescription history, current prescription regimen, and side effect information, for example, dosage information, length of time a subject has been taking a prescription, and other drugs known to cause negative side effects with a subject's current prescription regimen.

Electronic Medical Records (EMRs) can relate to records obtained and stored by a subject's doctor, clinician, insurance company, hospital and/or other facilities where a subject is a patient. In some embodiments, the doctor can include a medical doctor, a dentist, an optometrist, a therapist, a chiropractor, and anyone who provides healthcare services to the subject. Electronic medical records (EMR) can comprise, for example, CAT scans, MRIs, ultrasounds, blood glucose levels, diagnoses, allergies, lab test results, EKGs, medications, daily charting, medication administration, physical assessments, admission nursing notes, nursing care plans, referrals, present and past symptoms, medical history, life style, physical examination results, tests, procedures, treatments, medications, discharges, history, diaries, problems, findings, immunizations, admission notes, on-service notes, progress notes, preoperative notes, operative notes, postoperative notes, procedure notes, delivery notes, postpartum notes, and discharge notes.

In some embodiments, data delivery is compliant with HIPAA standards. In some embodiments, data delivery is not compliant with HIPAA standards.

Non-limiting examples of the behavioral, health, and medical data that can be used by the system of the invention to help provide a subject with personalized behavioral changing goals include, sleeping habits, stress depression and anxiety levels, mood disorders, panic disorders, seasonal disorders, dementia, motion sickness patterns, home and family data, smoking patterns, body dysmorphic disorder, attention deficit disorder, bedwetting, postpartum depression, separation anxiety, migraines, medications, hormone replacement therapy, alternative treatments, vitamin, calcium, and nutritional supplements, blood disorders, cancer and neoplastic diseases, cardiovascular disorders, dental and oral diseases, digestive disorders, ear nose and throat diseases, endocrine disorders, eye diseases, genetic and rare diseases, immune system disorders, autoimmune diseases, infectious diseases including viral and bacterial diseases, mental health disorders, musculoskeletal and bone disorders, neurological diseases, dermatological disorders, nutritional and metabolic diseases, parasitic diseases, pediatric disorders, respiratory and pulmonary disorders, rheumatologic disorders, urological and kidney diseases, allergies, Alzheimer's disease, bladder incontinence, arthritis, HDL/LDL cholesterol levels, acute and chronic pains, cold and flu, immunizations, diabetes, appendicitis, inflammatory disorders, lactose intolerance, disease prevention exercise and activity, sexually transmitted diseases, or a combination thereof. Non-limiting examples of mood, affective and executive function disorders that can be monitored by a system of the invention include Alzheimers, Multi-Sensory Processing Disorders, Autism Spectrum Disorders, Traumatic Brain Injury, ADHD, PTSD, depression, bipolar, schizoid, Obsessive Compulsive Disorder, anxiety disorders, borderline personality, anorexia and bulimia, intermittent explosive disorder, Seasonal Affectic Disorder, Sleepwalking, Social Anxiety Disorder, Expressive Language Disorder, Addictions, Oppositional Defiant Disorder (ODD), and panic disorder.

Subjects of the invention can be individuals participating in rehabilitation programs, for example, physical therapy rehabilitation programs or addiction rehabilitation programs. For example, a subject seeking to comply with a prescribed physical therapy regimen can access the calendar platform of the method of the invention and populate dates and times when a physical therapy regimen can occur. A physical therapist can access the calendar platform, and populate objectives for the subject. The system of the invention can introduce a subject to other subjects who share, for example, a goal, a recommendation, a condition, a treatment regimen, a therapist, and/or a geographic location. The system of the invention can provide recommendations, for example, on recommended diets prior and post therapy, recommended attire to be worn during physical therapy, and recommended extent of physical activity to be undertaken outside of therapy. The subject can, for example, use the messaging system to communicate with the physical therapist in between sessions, and discuss, for example, the possibility of pursuing additional therapy exercises home. The system of the invention can reward the subject for completing a prescribed set of exercises with a plurality of rewards.

The system of the invention can recommend to a subject seeking tobacco cessation a plurality of alternatives to tobacco consumption, including changes in a subject's routine, for example, if the subject smokes after eating, the system of the invention can recommend taking a walk after eating.

Types of Behaviors that can be Monitored, Changed and Scored.

The system of the invention identifies germane, pragmatic, and consequential goals and presents objectives and recommendations towards achieving a goal to a subject. A plurality of distinct types of behaviors can be monitored, changed, and scored by the system of the invention. Non-limiting examples of types of behaviors include physical, intellectual, social, emotional, environmental, and spiritual behaviors. Examples of such types of behaviors include maintaining healthy eating habits, managing weight, participation in physical activities, participation in recreational activities, participation in social activities, friendship maintenance, getting a minimum amount of sleep at night, practicing safe sex, hitting, head butting, biting, screaming, spitting, throwing, punching, kicking, temper tantrums, attachment, repetitive behaviors, obsessive compulsive behaviors, obsessive behaviors, compulsive behaviors, studying habits, teaching habits, workaholic habits, competitive drive, managing boredom, intake of alcohol, consumption of tobacco products, substance abuse, addictions, lying, inappropriate sexualized behavior, scheduling regular self-exams, scheduling regular medical checkups, echolalia, cursing, blabbing, verbal violence, intimidation, anger management, physical violence, ability to follow directions, ability to focus, organizational behaviors, bullying, defiance, aggression, anxiety-causing behaviors, stress-causing behaviors, depression-causing behaviors, passive aggressive behavior, hostility, superiority, neutrality, empathy, spontaneity, detachment, certainty, loitering, stealing, deprecating property, listening, communicating, religious behavior, religious participation, and praying.

Behavioral-changing decisions can involve all aspects of a subject's life, including mental, physical, dietary, emotional, intellectual, and spiritual aspects. A subject can be someone who spends too much time watching television, a subject can be someone with obsessive-compulsive behaviors, a subject can be an individual suffering from insomnia, and/or a subject can be someone struggling to recover from the loss of a loved one. Furthermore, pursuit of behavioral-changing regimens can provide structured opportunities to increase knowledge and skills in specific areas, for example, stress management, or environmental sensitivity. Behavioral-changing decisions can help subjects understand the complexity of ingredients for optimal psychosocial and physical well-being. Behavioral-changing regimens can provide knowledge of proper exercise, for example, resistance training, endurance training, flexibility training, and balance training, nutrition, peer support, and the ability to cope with the psychological and physical health changes experienced by a user. Behavioral-changing regimens can be helpful in promoting independence, functionality, health, and overall well-being in a subject. Since different people learn differently, people can require very different systems to support growth or change. Therefore, an effective system to support behavioral change can be personalized to a subject.

The system of the invention can help identify personalized behavior-changing objectives and offer personalized recommendations for a plurality of types of behaviors. Categories of behaviors can include, for example, speech, communication, friendship and relationship, social, community, and work related behaviors. For example, a smoking sensor within a subject's home can identify when a subject is consuming tobacco products. A second sensor, such as a motion sensor within the subject's home, can identify motion patterns associated with the subject's tobacco consumption, such as walking within the living room, resting, or walking in the kitchen. A system of the invention can combine the detected behavior with a subject's history, and/or with a subject's medical history to make correlations and provide personalized recommendations. For example, the system of the invention can correlate patterns of stress, boredom, relaxation, sadness, and/or hunger with a subject's behavior and provide recommendations specifically-targeting the trigger for the subject's decision to smoke. For example, the system can recommend a number of social and physical activities to a subject that smokes out of boredom. The invention can give the subject a high score for adhering to the recommendation, and the subject can receive a plurality of rewards for adhering to the recommendation.

The system of the invention can search for a plurality of personalized behavior-changing recommendations, encompassing a plurality of types of behaviors and areas of health, including, for example, physical, intellectual, social, emotional, environmental, and spiritual behaviors. For example, the system of the invention can identify predisposing and reinforcing social factors inhibiting commitment to behavior-changing decisions. For example, an ingested first sensor within a subject's person can identify subjects who are predisposed to developing high cholesterol, and a second audio sensor within a subject's kitchen can determine social factors contributing to the persistence of the behavior, such as the fact that the subject lives with family members who frequently consume high calorie meals. The system of the invention can make recommendations to support effectively a subject's commitment to a lower calorie diet, including sending the subject health reminders whenever the second sensor senses activity in the kitchen by multiple individuals.

For example, the system of the invention can help subjects with HDL and LDL levels indicative of risk for hyperlipidemia identify personalized behavioral-changing objectives that can contribute to preventing hyperlipidemia. In some embodiments, the system can determine that the subject exercises one hour a week, has a stressful job, and has a fatty diet. The system can process the combined behavioral and medical data to generate a series of personalized objectives and recommendations for the subject. The recommendations can include, for example, physical activities that can be performed to reduce stress and lower cholesterol levels, and foods to be included in a healthy diet to control cholesterol levels. The objectives can include, for example, loosing a suggested amount of weight by a specific date. The system can supply the subject with recommended milestones, and can populate the calendar platform with a timeline for milestone achievement. Furthermore, the system can facilitate communication with, for example, healthcare providers by providing convenient communication access through the messaging platform.

### Reward System.

To support lifestyle changes, the system of the invention can provide a comprehensible and explicit course of action for achieving an objective in the form of recommendations. The system of the invention produces recommendations that can constructively outline a strategy for achieving an objective(s), effectively speaking to challenges in pursuing/achieving objectives. Recommendations can be personalized to understand a subject's vulnerabilities to lapses, and they can adapt to developing alternative coping strategies. Recommendations can raise a subject's emotional awareness, remind people of their goals, and reframe challenges. Reward structures can be personalized to the latency, duration, inter-response time, conditioning, magnification, attenuation, including contingencies and/or contiguities of the stimuli, optimal response, support and/or motivation, rate and celebration of positive behavior reinforcement.

To incentivize compliance with behavioral changing regimens, the present invention provides a reward structure. The user can personalize the reward system by entering information on interests and motivations of each subject. The subject can personalize the reward system by entering information on their own interests and motivations. The reward system can comprise a reward and/or credit module, which can award points or credits. The reward can be based on an effort by the subject, an outcome achieved by the subject, or both. Non-limiting examples of the effort of the subject include setting a goal and/or pursuing/achieving the same, reading/sending relevant e-mail, updating the personal calendar, interacting with the social network provided by the invention, and communicating with a health-care provider. The invention can acquire information regarding, for example, the occurrence, frequency, duration, and repetition of a behavior using sensors, and the invention can provide rewards based on the behavior. Non-limiting examples of a reward include points towards completion of a certificate, points redeemable for services from a redemption network, cash health and wellness products, discounts within a redemption network, and improved status, such as premier status. The reward can be redeemed using one or more effective means of delivery, such as email, text messages, mail, and telephone.

In some embodiments, effort can comprise participation in activities associated with a wellness program of an organization. As a non-limiting example, a subject's effort toward a wellness program can comprise participation in one or more smoking cessation programs, stress management programs, education programs, walking programs or challenges, support groups, informal sports leagues, weight loss programs, fitness center memberships, medical self-care training programs, wellness seminars or health and wellness fairs. In some embodiments, a subject receives and redeems credits for efforts, for example, opening the refrigerator door fewer times than recommended by the objective engine.

The present invention links rewards and incentives with messaging and calendar platforms that can broadcast successful goal achievements to a plurality of social network platforms. The use of a reward system can grant the subject satisfaction and one or more metrics that can be used to determine the level of achievement, commitment, confidence, understanding, motivation, awareness, and even expertise a subject possesses about one or more behaviors or trends. A subject can achieve a higher score based on an effort by the subject, and subjects can have immediate recognition and appreciation for the efforts they have put into accomplishing a goal. The subject can receive immediate positive reinforcement from the social network system provided by the invention.

The reward system can comprise providing a disincentive to a subject according to lack or inadequate progress towards a personalized goal. A non-limiting example of a disincentive includes loss of rewards.

When a subject accumulates enough credits to redeem a reward, a list of one or more rewards that can be redeemed by a user using the credits can be sent to a user via one or more text messages. The number of unredeemed credits can be, for example, sent to a user via one or more text messages. Any of the text messages described herein can be sent periodically, or can be sent when the number of unredeemed credits reaches an upper threshold. For example, the text messages can be sent once every day, week, or month, or can be sent when the number of unredeemed credits of a user reaches, for example, 100, 500, 1000, 2500, 5000, or 10000 credits.

In some embodiments, reward points can be awarded to users and/or to efforts not related to a subject's objective. For example, a user can receive reward points or credits for supporting a subject to achieve or make progress towards an objective. A subject can receive reward points or credits for supporting another subject to achieve or make progress towards an objective.

In some embodiments, accrued credits or points accrued by a subject can be redeemed by the subject, for example, for one or more certificates, cash bonuses, cash rewards, health and wellness products and services, and other products and services, and discounts and other value and added services, within a redemption network or a network of partners. In some embodiments, the redemption network or network of partners can include healthcare providers, employers, insurers, Medicare, Medicaid, international payers, health IT companies, and other consumer internet companies.

The system establishes a score based on the subject's behavior, and archives the score for comparison with future behaviors. As the subject's score improves, progress is recorded, and is visible on the subject's on-line account. The subject can participate in a rewards system based on improvement in the score, and compliance with the recommendations.

### Positive Feedback System.

The present invention also provides a method for the user to receive input regarding their progress towards an objective. The messaging and the calendar components of the system of the invention allow users to enter objectives into an objective engine and have them available for selection by the subject. For example, health care providers and caregivers can enter personalized goals for patients (subjects). The present invention can also help with maintaining constant communication between the health care provider and the subject. The communication can be particularly important in the interval period between medical encounters.

Another aspect of the present invention relates to a method for integrating compliance and social networking. The user can communicate with others using a messaging platform or a calendar platform provided by the system of the invention. Subjects can weigh suggestions by different users, including suggestions received electronically by the system of the invention and suggestions received during in-person social interactions. The present invention empowers users and subjects to participate proactively in the conception and implementation of behavior-changing objectives, which can improve the overall success of achieving an objective. Furthermore, the social network provided by the invention helps subjects integrate behavior changing goals into daily lives, providing a positive feedback loop system.

Emotion plays a major role in attitude change, social influence, and compliance. The present invention also provides a system for the use of a messaging and calendar platforms to manage expectations and emotions. For example, a subject can consider indulging in a food craving. The system of the invention can note evidence of behaviors associated with a subject indulging a food craving, for example, a refrigerator and a cupboard being accessed at about the same time, or the microwave oven being accessed shortly after the freezer was opened. Upon sensing the behavior, the system provides a recommendation to the subject, which can include recommending engagement with a supportive social network system through the messaging platform of the invention. The system can establish a score based on the subject's behavior, for example, a subject can receive a high score for engaging with a supportive social network support system, and resisting the food craving. The subject can receive a reward for resisting the food craving, for example, a free pass in a local gym.

A positive feedback system loop can be a personalized reward system. The system can reward a subject who resisted a food craving by presenting the subject with a shopping coupon or a plurality of other desirable rewards. The system can populate the calendar platform with target rewards, for example, a subject whose objective is to lose weight can be incentivized to comply by being presented with the possibility of receiving tickets to a concert upon achieving a future milestone. A subject can earn rewards on behalf of another subject, another user, or an individual not associated with the invention. For example a subject can earn rewards on behalf of a workout buddy, an individual with breast cancer, an institution they are associated with, such as a school, or a subject can earn rewards on behalf of a philanthropic project, such as a clean water project in a foreign country.

### Behavioral Change Compliance.

Compliance, or adherence, can describe, for example, the degree to which a subject adheres to an objective, a strategy, and/or follows directions, including regimens prescribed by health care providers and regimen goals established by oneself. Compliance can refer to adherence to behavior-changing decisions, behavior-changing programs, wellness programs, health care regimens, life style decisions, and patient compliance. Patient compliance has long been a common concern in medical practice, and can refer to adherence and persistence to a regimen of care recommended by a health care provider.

A plurality of factors can influence adherence to behavioral-changing objectives, for example, the relationship of a subject with health care providers, family members, colleagues, co-workers and the relationship of a subject with oneself, for example, having high levels of self-esteem. A positive relationship with members of a subject's network can be an important factor in improving compliance. The system of the invention provides a social network that allows users to communicate with, for example, friends, family, health care providers, and subjects with shared interests. This social network can be a critical compliance support system, helping users reach out to others at decisive times. For example, a subject can receive personal messages from clinicians, health care providers, family members, and friends supporting compliance with cigarette smoking behavioral changing objectives. At any time, a subject can access the message and calendar platforms of the invention and a subject can visualize a subject's own success rate.

The present invention also provides a system for the use of the platform by health care payers to increase compliance and engagement of their members in programs offered by organizations. In some embodiments, an organization can include a health care provider, a company providing educational content to a subject, or a third party company. A company can include, for example, an employer, a sports team, a school, a government entitlement program. A health care provider can be an individual or an institution that provides preventive, curative, promotional, or rehabilitative health care services in a systematic way to individuals, families or communities. In some embodiments, an individual health care provider can be a health care professional, an allied health professional, a community health worker, or another person trained and knowledgeable in medicine, nursing or other allied health professions, or public/community health. Non-limiting examples of institutional health care providers include hospitals, clinics, primary care centers, hospices, convalescent homes, outpatient facilities, medical homes, and other service delivery points when medical encounters occur.

The system and method of the invention can help with adherence to a plurality of rehabilitation regimens, including health rehabilitation programs and addiction rehabilitation programs. The relationship of self-perception of illness, addiction, and compliance with regimens influences attitudes, the number of hospitalizations, the number of emergency care visits, global health, and compliance with rehabilitation regimens.

### Example 1

### Network Diagram Describing the Flow of Information Among a User(s), a Subject, and Calendar and Messaging Interfaces

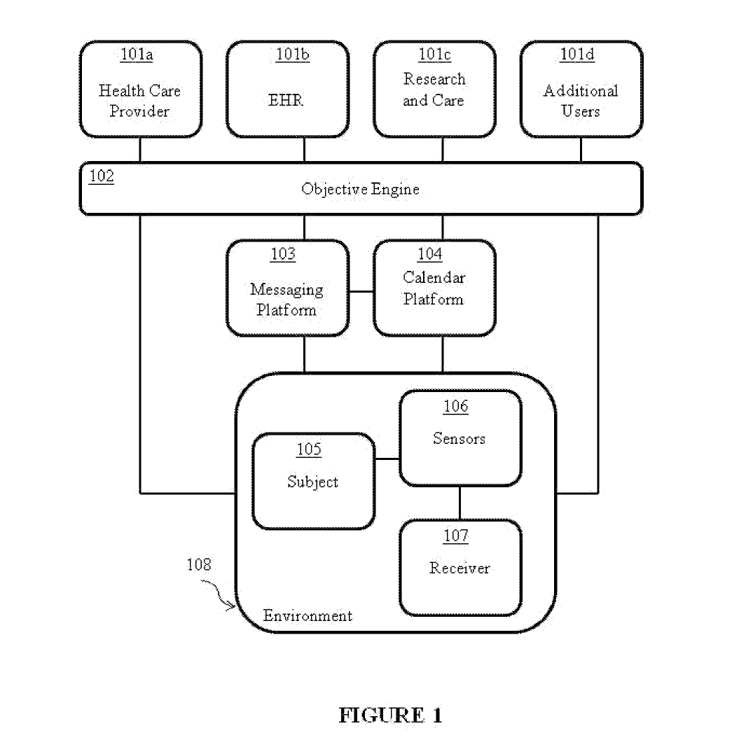

FIG. 1 illustrates how a user can view and interact with the system of the invention. The system of the invention collects data from a plurality of different data sources and users. Data sources can be: a) health care providers 101a; b) electronic health records (EHRs) 101b; c) research and care delivery organizations 101c; d) pharmaceutical companies; e) health insurance companies; and f) a plurality of other users 101d, including subjects themselves 105. The objective engine 102 communicates with a plurality of data sources 101a, 101b, 101c, and 101d, and compiles and processes user data to provide users with personalized objectives. The objective engine presents the data to the user on a messaging platform 103, a calendar platform 104, or both 103 and 104. Receivers 107 and sensors 106 receive and process data input from the subject 105, from the environment 108, or from both 105 and 108.

For example, a health care provider 101a can prescribe an exercise regimen to a user. The exercise regimen can require the user to walk three miles twice a week. A health care provider 101a can use the objective engine 102 to communicate with a subject in the message platform 103. The message platform 103 can display instructions providing the user with details on, for example, how fast they should walk the recommended three miles of exercise, how steep should the elevation of the exercise course be. The health care provider can use the objective engine 102 to add proposed dates and times for when the exercise regimen should occur. Those proposed dates and times are added to the calendar platform 104 and can be viewed by the user himself and authorized users. Authorized users can be, for example, health care providers, custodians, caretakers, and family members. The subject 105 can add, for example, an exercise objective to the calendar platform 105. The message platform 103 and the calendar platform 105 can be accessed from a plurality of devices, for example, smartphone(s), tablet(s), desktop computer(s), laptop computer(s) and a plurality of mobile devices with different interfaces and operating systems. The events on the calendar platform 105 or on the message platform 103 can be geotagged. For example: a) accelerometers can collect information on velocity (how quickly the user walks, runs, and moves); b) the distance between events can be determined and an estimation can be made whether the person walked, ran or drove from an initial point to a final point. Receivers 107 and sensors 106 can determine the user interaction with the environment 108. For example, a pedometer can provide information on how quickly a subject walks, runs, and moves. For example, a senior citizen following an exercise regimen prescribed by a physician can wear a sensor 106 to determine how fast and/or how often the senior citizen walks in an environment 108. The data on the senior citizen motility can be accessed by authorized health care providers 101a using the application programming interface 102.

### Example 2

### Messaging Platform or a Calendar Platform

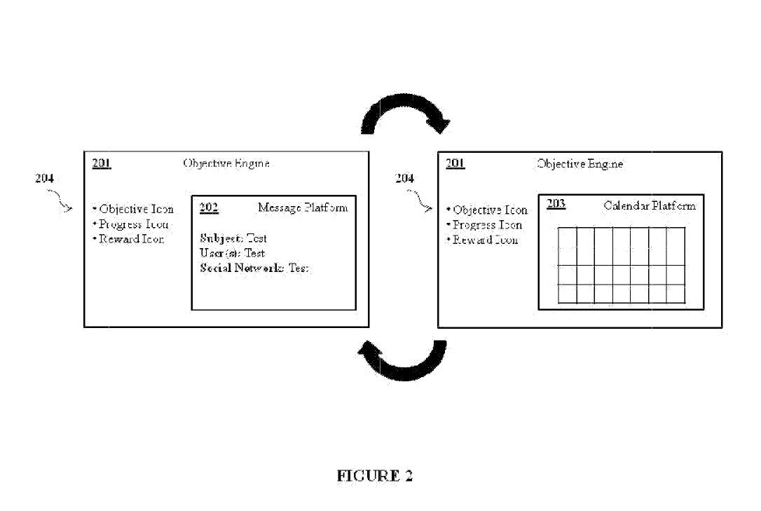

FIG. 2 depicts an illustrative messaging platform or a calendar platform. A subject seeking to change, for example, a negative behavior pattern can start by accessing the objective engine 201 of the system of the invention from a plurality of devices, for example, mobile phone(s), tablet(s), and desktop computer(s). The objective engine 201 mines available data across databases and uses personalized information to generate unique objectives for the subject. Data mining can occur across, electronic-, magnetic-, and optical-based databases containing therein personal health information and pertinent behavioral data. The objective engine 201 can use data obtained by receivers in communication with sensors in the environment to create personalized objectives. A messaging platform 202 within the objective engine 201 can be used for social messaging and objective discussion with health care providers, educators, family and friends, and others seeking similar objectives. A calendar platform 203 within the objective engine 201 can post progress on objective achievement and can use factual behavioral patterns detected by sensors and transmitted to receivers, to monitor progress towards an objective and present rewards. A monitoring page within the objective engine can present the user with, for example, clickable icons containing information within regarding the Objective, Rewards, and Progress 204.

### Example 3

### Computer Architectures

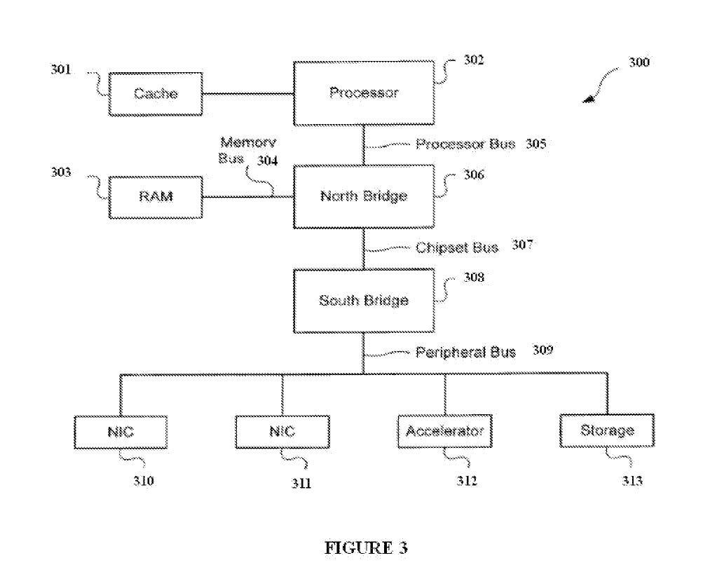

Various computer architectures are suitable for use with the invention. FIG. 3 is a block diagram illustrating a first example architecture of a computer system 300 that can be used in connection with example embodiments of the present invention. As depicted in FIG. 3, the example computer system can include a processor 302 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 3, a high speed cache 301 can be connected to, or incorporated in, the processor 302 to provide a high speed memory for instructions or data that have been recently, or are frequently, used by processor 302. The processor 302 is connected to a north bridge 306 by a processor bus 305. The north bridge 306 is connected to random access memory (RAM) 303 by a memory bus 304 and manages access to the RAM 303 by the processor 302. The north bridge 306 is also connected to a south bridge 308 by a chipset bus 307. The south bridge 308 is, in turn, connected to a peripheral bus 309. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 309. In some architectures, the functionality of the north bridge can be incorporated into the processor instead of using a separate north bridge chip.

In some embodiments, system 300 can include an accelerator card 312 attached to the peripheral bus 309. The accelerator can include field programmable gate arrays (FPGAs) or other hardware for accelerating certain processing.

### Software Interface(s).

Software and data are stored in external storage 313 and can be loaded into RAM 303 and/or cache 301 for use by the processor. The system 300 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 300 also includes network interface cards (NICs) 310 and 311 connected to the peripheral bus for providing network interfaces to external storage, such as Network Attached Storage (NAS) and other computer systems that can be used for distributed parallel processing.

### Computer Systems.

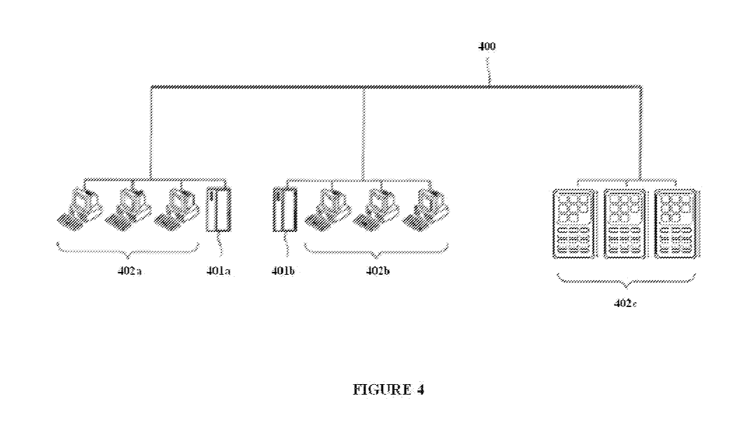

FIG. 4 is a diagram showing a network 400 with a plurality of computer systems 402a, and 402b, a plurality of cell phones and personal data assistants 402c, and Network Attached Storage (NAS) 401a, and 401b. In some embodiments, systems 402a, 402b, and 402c can manage data storage and optimize data access for data stored in Network Attached Storage (NAS) 401a and 402b. A mathematical model can be used for the data and be evaluated using distributed parallel processing across computer systems 402a, and 402b, and cell phone and personal data assistant systems 402c. Computer systems 402a, and 402b, and cell phone and personal data assistant systems 402c can also provide parallel processing for adaptive data restructuring of the data stored in Network Attached Storage (NAS) 401a and 401b. FIG. 4 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

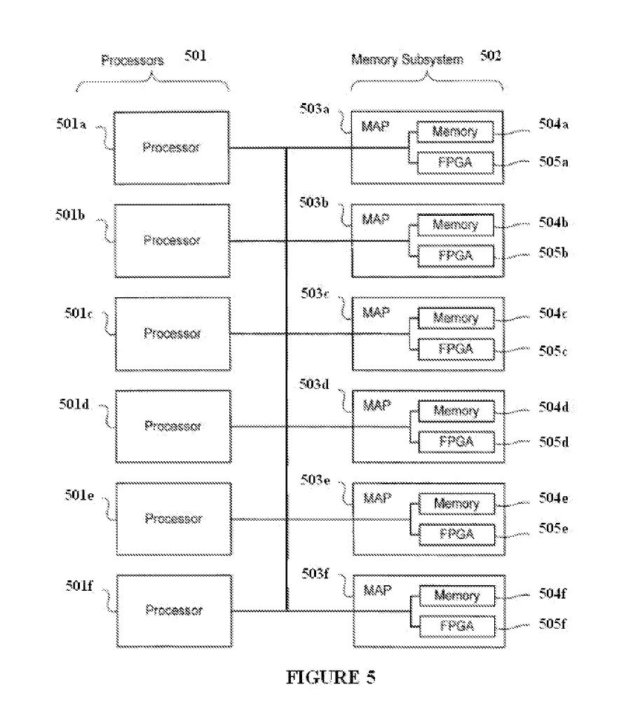

FIG. 5 is a block diagram of a multiprocessor computer system using a shared virtual address memory space. The system includes a plurality of processors 501a-f that can access a shared memory subsystem 502. The system incorporates a plurality of programmable hardware memory algorithm processors (MAPs) 503a-f in the memory subsystem 502. Each MAP 503a-f can comprise a memory 504a-f and one or more field programmable gate arrays (FPGAs) 505a-f. The MAP provides a configurable functional unit and particular algorithms or portions of algorithms can be provided to the FPGAs 505a-f for processing in close coordination with a respective processor. In this example, each MAP is globally accessible by all of the processors for these purposes. In one configuration, each MAP can use Direct Memory Access (DMA) to access an associated memory 504a-f, allowing it to execute tasks independently of, and asynchronously from, the respective microprocessor 501a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 5, system on chips (SOCs), application specific integrated circuits (ASICs), or other processing and logic elements. For example, the Set Processor and Optimizer can be implemented with hardware acceleration through the use of a hardware accelerator card, such as accelerator card 312 illustrated in FIG. 3.

### Example 4

### Eating Habits

A system of the invention can be used to monitor a subject's eating habits within the subject's home. The subject can wear a geolocation sensor, which is in communication with a receiver. The global positioning sensor allows the system to monitor the subject's location within the subject's home. Other sensors monitor the use of various home appliances and devices, such as the subject's refrigerator, freezer, kitchen cabinets, cupboards, and other food-storage locations, which are each equipped with an electromagnetic sensor, which detects that the food-storage location has been opened and closed. The system notes when a food-storage location is accessed while the global positioning sensor is within a reasonable distance of the food-storage location, thereby suggesting that the subject wearing the global positioning sensor is accessing the food-storage location.

The subject's oven, range, stove, microwave oven, and other cooking appliances are similarly equipped with electromagnetic sensors to monitor when an appliance is activated/deactivated or opened/closed. The system notes when a cooking appliance is accessed while the global positioning sensor is within a reasonable distance of the cooking appliance, thereby suggesting that the subject wearing the global positioning sensor is accessing the cooking appliance.

The system notes such interactions, and analyzes the frequency, duration, and time of day of the aforementioned behaviors. The system compares these observations with evidence of other activities occurring at about the same time, for example, a refrigerator and a cupboard being accessed at about the same time, or the microwave oven being accessed shortly after the freezer is opened.

Upon detecting a behavior, the system archives the behavior by subject, date, and time. The system optionally sends the subject electronic messages or calendar reminders, or request for relevant information. Such relevant information includes the nature of the behavior undertaken, why the behavior is undertaken (i.e., hungry, bored, unhappy, etc.), what is eaten, how much is eaten, and how the food is prepared. The subject can explain a false positive by noting that nothing is eaten, for example, that the subject is stowing groceries purchased recently. Truthful responses improve the overall quality of the output.

The system searches a database to find information relevant to the identified behavior. The system provides recommendations to the subject to improve the behavior. Recommendations can include alternative eating schedules, food types, and preparations; techniques and exercises for overcoming cravings and destructive eating habits; and goals for achieving improvement in eating habits.

The system can establish a score based on the subject's behavior, and archives the score for comparison with future behaviors. As the subject's score improves, progress is recorded, and is visible on the subject's objective engine. The subject can participate in a rewards system based on improvement in the score and compliance with the recommendations.

### Example 5

### Addictive Behavior

The method of the invention can help subjects with substance abuse addiction(s) adhere to a rehabilitation program. An alcoholic can provide a breath sample into a breathalyzer sensor, to estimate the subject's blood alcohol content. Additional sensors, such as pedometers and motion detectors, monitor motion patterns within the subject's home, such as wobbling motion patterns. All sensors are in communication with a receiver.

The system detects a measurable alcohol level in the subject's blood. The system searches a database to find information relevant to alcoholism. The system monitors the subject's drinking habits as detected by the sensors, and the system provides personalized recommendations to improve the drinking habit of the subject, such as replacing alcohol consumption with a physical activity, being active in the community, and finding/participating in a positive social network.

Upon detecting a measurable level of blood alcohol, and/or detecting a stumbling motion pattern, the system of the invention uses the messaging platform to communicate with a rehabilitation sponsor. The system of the invention can use the message platform to reach out to support communities, such as alcoholic anonymous. The subject can receive support from recovered alcoholics in the community, and reach out to a sponsor. The system can use the geolocation aspect of the sensors to send personalized recommendations within the messaging platform with information on nearby alcoholic anonymous meetings. The system sends recommendations, including, reaching out to a sponsor, and/or pursuing a healthier alternative to drinking, such as chewing gum or going for a run.

An alcoholic can use the calendar platform of the invention to keep track of the number of days in which the subject stays sober, and how frequently the subject feels the urge to consume alcohol. The system of the invention, upon detecting a behavior, such as a behavior associated with alcohol consumption, archives the behavior by subject, date, and time in the calendar platform. The system compares these observations with evidence of other activities occurring at about the same time, for example, an unsteady gait detected by a motion detector, or an unsteady pedometer pattern shortly after the behavior is detected. The system notes such interactions, and analyzes the frequency, duration, and time of day of the aforementioned behaviors. The system matches the patterns of symptoms to earlier behavior to predict whether they have been drinking or not, and whether they have been engaging in a replacement behavior.

The system of the invention can populate the calendar platform with success reminders, such as keeping sobriety for a period of time. The system can populate the calendar platform with pop-up reminders, such as photos of family members, recent progress in a job, and other motivations for compliance with managing alcohol consumption. The system can provide a high score for a subject that stays sober in a number of different of interfaces-calendars, scoreboards, and games. The subject can share this score within the social network component of the system of the invention, and the subject can receive encouraging and congratulatory messages from the community. The system can provide rewards to the subject for not relapsing.

### Example 6

### Sleeping Patterns

A system of the invention is used to monitor a subject's sleeping habits. The subject wears devices that comprise heartbeat, respiration, altimeter, proximity, light, gyroscope, and accelerometer sensors, which are in communication with a receiver, and which monitor the subject's heartbeat, respiration, movement and ambient light patterns during sleep. These sensors allow the system to monitor the heart rate, respiration, movement and light throughout the day, including during the hours of uninterrupted unconscious sleep at both daytime and nighttime, when the signs being monitored decrease significantly, ie. heart-rate can go down by 10-30 heartbeats a minute. Sensors are in communication with a receiver.

The subject has a second monitoring device wherein the subject inputs within the Calendar platform the time that a subject goes to sleep, and the time that a subject wakes-up from sleep. The system notes the frequency, duration and length of uninterrupted sleep as detected by the heartbeat sensor. The system notes the frequency, duration and length of uninterrupted sleep as inputted by the subject.

Upon detecting the behavior, the system archives the behavior by the subject. The system adds its own sleep log to the calendar platform listing the start time, and end time of uninterrupted sleep. The system searches within a database for personalized behavioral change for recommendations that are personalized for the subject. The system searches the subject's medical records to identify past and present medical problems, a history of insomnia and other information that is relevant to providing personalized recommendations.

The invention analyzes patterns of data across devices, including the sleep log created by the subject into the Calendar Platform, and the sleep log created by the heart monitor sensor. The system searches a database of behavioral recommendations, and identifies recommendations personalized for the subject. For a subject that suffers from insomnia, and wants to sleep a minimum of six uninterrupted hours of sleep a night, the system can recommend going to bed at the same time every night, avoiding daytime napping, avoiding a noisy sleeping environment, undertaking a physical exercise regimen, avoiding watching television, and avoiding using computer or electronic devices while in bed. The combination of sensors sense behaviors sleepwalking, apnea, sleep terrors, sleep talking, and narcolepsy behaviors.

The subject tracks progress towards achieving a goal of sleeping six hours a night in the calendar platform. The messaging platform sends the subject reminders of recommendations, including daily reminders to go to bed at or around the same time, reminders to turn off electronic devices in the bedroom, and reminders to pursue physical activity. The subject accumulates rewards for following the recommendations, such as earning free-passes and/or discounts in a nearby gym.

### Example 6

### Anger Management

A system of the invention is used to manage a subject's anger. The subject wears a microphone sensor that detects fluctuations in the tone of voice of a subject. The subject wears a heartbeat monitor that detects fluctuations in heartbeat of the subject. The subject optionally wears skin turgor, Galvanic Skin Response (GSR), and motion sensors. All sensors are in communication with a receiver.

The subject engages in daily life activities, such as commuting, working, interacting with co-workers, eating, bathing, dressing, interacting with family members, homemaking, and leisure activities. The microphone sensor notes when the tone in a subject's voice is associated with anger, surprise, or happiness. The heartbeat, movement and GSR sensors detects increases in heartbeat associated with a subject's anger.

The system notes such interactions, and analyzes the frequency, duration, and time of day of the aforementioned behaviors. The system compares the data points from the microphone sensor suggesting that the subject is angry, with data points from the subject's heart or GSR monitor sensor. The system compares both activities to determine the occasions where anger is detected.

Upon detecting a behavior, the system archives the behavior by the subject. The system creates a log within the calendar platform of the days, times and locations where anger was sensed. The system optionally sends the subject messages via the messaging platform with a brief questionnaire, or request for relevant information. Such relevant information includes the nature of the behavior undertaken by the subject (ex: acting out by screaming, throwing, engaging in verbal violence, etc.), and the nature of the trigger for the behavior (ex: working, commuting, interacting with family members, etc.) with the geolocation data. The subject can explain a false positive by noting that the subject feels no anger, and does not act out of anger. Truthful responses improve overall quality of the output.

The system searches a database to find information relevant to the identified behavior. The system provides recommendations to the subject to improve the behavior. Recommendations are anticipatory, suggesting that the subject should avoid certain locations, proximity to people, or recommending that the subject should engage in remedial activities, such as listening to music when something triggers an anger response, taking a walk, alternating a commuting schedule, and participating in support sessions provided by the social network of the invention.

The system establishes a score based on the subject's behavior, and archives the score for comparison with future behaviors. The system establishes patterns of sensor data which identify likely antecedants or triggers to the behavior as a form of early warning system. As the subject's score improves, progress is recorded, and is visible on the subject's on-line account. The subject participates in a reward system based on improvement in the score and compliance with the recommendations.

### Example 7

### Obsessive Compulsive Behaviors

A system of the invention is used to manage a subject's obsessive compulsive behavior that includes excessive double checking of things, such as locks, appliances, and switches. The subject wears a geolocation sensor that is implanted into the subject's body. The sensor is in communication with a receiver. The global positioning sensor allows the system to monitor the subject's location within the subject's home. Other's sensors monitor the use of various home appliances and devices and the position of his body part/s involved in the compulsive behavior.

The subject's door knobs, switches, stove, and other frequently-visited locations are each equipped with an electromagnetic sensor, which detects that the frequently-visited location has been touched. The system notes when a frequently-visited location is touched while the global positioning sensor is within a reasonable distance of the frequently-visited location, thereby suggesting that the subject wearing the global positioning sensor touched the frequently-visited location.

The subject's door knobs, water taps, switches, stove, frequently-visited locations, and other home fixtures are similarly equipped with electromagnetic sensors to monitor when a home fixture is activated/deactivated and/or opened/closed, and/or touched. The system notes when a home fixture is repeatedly touched, activated/deactivated and/or opened/closed while the global positioning sensor is within a reasonable distance of the home fixture, thereby suggesting that the subject wearing the global positioning sensor accesses the cooking appliance.

The system notes such interactions, and analyzes the frequency, duration, and time of day of the aforementioned behaviors. Upon detecting a behavior, the system archives the behavior by subject, date, and time. The system optionally sends the subject electronic correspondence via the messaging platform with requests for relevant information. Such information can include a response on an actionable item: “I see that you have touched the door a number of times, would you like to mark the door as closed within the Calendar platform?” The subject marks the door as closed within the Calendar platform, and the calendar platform logs the behavior.

The system searches a database to find information relevant to the identified behavior. The system provides recommendations to the subject to improve the behavior, thereby reducing the obsessive compulsive behavior. A recommendation can include re-directing the subject to the calendar platform and reminding the subject that the door has been closed or redirecting the subject to functionally equivalent replacement behavior.

The system establishes a score based on the subject's behavior, and archives the score for comparison with future behaviors. As the subject's score improves, progress is recorded, and is visible on the subject's on-line account. The subject can participate in a rewards system based on improvement in the score and compliance with the recommendations. Reminders in the message and calendar platform of the invention remind the subject of improvements in mastering of the skill and provide a component of a positive reinforcement loop.

### Example 8

### Monitoring an Elderly Parent

A system of the invention is used to monitor an elderly parent residing at a nursing home. The parent is frail and forgetful, and the family seeks to provide support in a non-intrusive manner. The subject wears a geolocation sensor that is attached to the subject's body, in clothing or jewelry. The sensor is in communication with a receiver. The global positioning sensor allows the system to monitor the subject's location within the subject's home. Other's sensors monitor the use of various home appliances and devices.

The elderly parent's bathroom, stove, toilet, door frame, and other frequently-visited locations are each equipped with an electromagnetic sensor, which detects that the frequently-visited location has been visited by the subject. The system notes when the stove within the elderly parent's home has been turned on for unusually prolonged periods of time, thereby suggesting that the elderly parent forgot to turn the stove off.

The system notes such interactions, and analyzes the frequency, duration, and time of day of the aforementioned behaviors. Upon detecting a behavior, the system archives the behavior by subject, date, and time. The system optionally sends the elderly parent electronic correspondence via the messaging platform with requests for relevant information. Such information can include a response on an actionable item: “Hello, what are you cooking? I see that the stove has been on.” The elderly parent can reply to the message informing “I tried a new recipe” and the calendar platform logs the behavior.

The system sends the family of the elderly parent, who are authorized users of the invention, electronic correspondence via the messaging platform with updated information on the behavior. Such information can include a response on an actionable item: “I sense that your parent forgot to turn the stove off, would you like to call them?”

### Example 9

### Monitoring a Child Afflicted by Autism

A system of the invention is used to monitor a child with autism. The child wears a geolocation sensor that is implanted into or on the subject's body. The sensor is in communication with a receiver. The global positioning sensor allows the system to monitor the child's location. Other motion sensors monitor the motion of child within a perimeter. The child engages in daily life activities, such as playing, doing homework, interacting with co-workers, eating, bathing, dressing, interacting with family members, and leisure activities. The geosensor and the motion sensors note both the presence, and the absence, of activity.

The system notes such interactions, and analyzes the frequency, duration, and time of day of the aforementioned behaviors. The system compares the data points from the geolocation sensor, with data points from other associated motion sensors. The system compares both activities to determine the locations and occasions when the child is active.

Upon detecting movement and activity, the system archives the motion of the child. The system creates a log within the calendar platform of the days, times and locations where movement and activity was sensed. The system uses the information to determine behavioral patterns that are specific to the autistic child. The system determines that the child is most active between 8-10 am. The system also monitors the child's movement within a perimeter, and the system sends a message to the parents if the child strays away from a designated perimeter.

The system searches a database to find information relevant to the identified behavior. The system provides recommendations to the parents that reflect the identification of the 8-10 am period of time as a time when the child is most active. Recommendations can include a suggestion for scheduling productive activities, such as therapy sessions, during the 8-10 am period of time, which appears to be a personalized high-energy time period for the child.

The parents schedule a therapy session for the child between 8-10 am. The system establishes a score based on the child's behavior during that time interval, and the system archives the score for comparison with future behaviors. As the child's score improves, progress is recorded, and is visible on the child's on-line account. The parents can use this metric as a quantitative way to identify progress in their child's response to a change in an activity, schedule, or routine. The invention correlates changes in patterns of behavior with side effects of medications, illnesses, changes in staffing, and program efficacy for goals targeting behaviors which can be measured by movement.

### Example 10

### Correlating a Behavior with a Biometric Marker

A system of the invention is used to help a subject cope with stress, and to help a subject reduce stress levels. The subject swallows a pill comprising a biosensor, which is in communication with a receiver. The biosensor allows the system to detect the presence of a cytokine, which is normally found in the blood of stress induced patients. The subject swallows a second pill, also comprising a biosensor, which allows the system to detect the presence of a reference protein within bodily fluids. Both sensors are in communication with a receiver.

The system archives the cytokine and reference protein levels detected by the sensors throughout the day, thereby providing a record of those biometric markers that is unique to the subject. The system inputs the sensed levels of the cytokine and the reference protein detected by the biosensor in the Calendar platform of the invention. Additionally the subject wears a Galvanic Skin Response (GSR), and positional sensors, which detect stress and agitation. The subject self-reports his daily activities within the Calendar platform of the invention by providing a description of low, medium, and high stress moments to the Messaging and the Calendar Platforms.

The system archives the behavior log written by the subject. The system compares the self-reported stress levels logged by the patients in the calendar platform with sensed levels of the cytokine and reference protein, and with signals sensed from the GSR and positional sensors throughout the day. The system identifies a correlation between sensing high levels of the cytokine and the subject reporting stress. The system also correlates cytokine and self-reported stress levels with behavior data sensed by the GSR and positional sensors. Triangulation of the data between sensors differentiates among different personal patterns and biomarker indexes of stress or agitation, against which future readings can be compared.

The system of the invention can populate the calendar platform with reminders of stress reducing activities. Upon sensing an increase in the levels of the stress associated cytokine, and differentiating amongst personalized patterns of cytokine, GSK, and positional signals, the system populates the calendar platform with pop-up reminders, such as reminders to engage in stress reducing activities. The recommendations provided by the system to the subject towards the subject's goal of coping and reducing stress help deliver a treatment intervention that is personalized to the subject's unique response to a particular pattern of stress or agitation (biomarker phenotype or subtype).

### Example 11

### Monitoring the Behavior of a Pet

A system of the invention is used to monitor the behavior of two family pets. The pets are subject's of the invention, and the pets can wear a geolocation sensor each, which is in communication with a receiver. The global positioning sensor allows the system to monitor the pets' location within the family's home. Other sensors monitor the occupancy by the pets of various locations within the family's home. The system senses when one of the pets tumbles a garbage pail, thereby suggesting that the pet wearing the global positioning sensor is engaging in disruptive behavior.

The family's living room, bedroom, and kitchen are similarly equipped with electromagnetic sensors to monitor when a garbage pail is touched by either pet or both, or when either pet or both lay on a bed. The system notes when the garbage pail is tumbled, thereby suggesting that a pet wearing the global positioning sensor is accessing the garbage within the garbage pail.

The system notes such interactions, and analyzes the frequency, duration, and time of day of the aforementioned behaviors. The system compares these observations with evidence of other activities occurring at about the same time, for example, the geolocation sensor indicating the location of a pet nearby a garbage pail at about the same time the electromagnetic sensor detected tumbling of the garbage pail, thereby identifying the pet engaging in disruptive behavior.

Upon detecting a behavior, the system archives the behavior by pet, date, and time. Each pet has its own behavior archived and logged. The system optionally sends the family electronic messages alerting them to the disruptive behavior by the pets. Such relevant information includes the nature of the behavior undertaken, such as the tumbling of the garbage pail, and an interpretation of the behavior by a system of the invention (i.e., your pet might be looking for attention from the family, etc.).

The system searches a database to find information relevant to the identified behavior. The system provides recommendations to the family to improve the behavior of the pet. Recommendations can include engaging in activities with the pet, walking the pet outside the family home, changing the location of the garbage pail.

The system can establish a score based on the pet's behavior, and archives the score for comparison with future behaviors. The pet's score can be used as a quantitative measure of behavior change progress. The family can participate in a rewards system based on improvement in the pet's score. The family can communicate with other pet owners using the system of the invention to support the pursuit of behavior changing goals for their pet(s).

### Example 12

### Correlating an Environment with a Physiological Behavior

A system of the invention is used to help a subject cope with allergies. The subject wears a wristband comprising a system of the invention. The wristband comprises two sensors. The first sensor detects the presence of pollen in an environment, and the first sensor chemically modifies the pollen by attaching a fluorescent tag to the pollen.

The fluorescently marked pollen can freely move within the wristband sensor. A second sensor, also comprised within the wristband monitors the levels of fluorescent marked pollen. Upon sensing a pre-determined threshold level of fluorescently marked pollen the second sensor transmits a beeping sound, thereby alerting the subject of the presence of an allergen in the environment. The subject decides to avoid the location where the presence of the allergen triggers is indicated by the beeping sound.

The wristband optionally comprises a computer system comprising a processor. The computer system archives the allergen levels detected by the sensors throughout the day, thereby providing a personalized record of the locations and times when the allergen was detected. The system inputs the sensed levels of the allergen detected by the system in the Calendar Platform of the invention. The system optionally sends reminders to the subject through a Messaging Platform of the invention alerting the subject of the presence of the allergen in the environment.

### Embodiments

The following non-limiting embodiments provide representative examples of the invention, but do not define the scope of the invention.

### Embodiment 1

A system comprising: a) a receiver; b) a first sensor in communication with the receiver, wherein the first sensor is in the environment, and wherein the first sensor detects the behavior and transmits a first signal associated with the behavior to the receiver, whereupon the receiver receives the first signal; c) a second sensor in communication with the receiver, wherein the second sensor is in the environment, and wherein the second sensor detects the behavior and transmits a second signal associated with the behavior to the receiver, whereupon the receiver receives the second signal; and d) a computer system comprising a processor, wherein: 1) the receiver sends the first and second signals to the computer system; and 2) the computer system compares, by the processor, the first and second signals to confirm that the behavior occurred.

### Embodiment 2

The system of Embodiment 1, further comprising wherein: 3) the computer system searches a database comprising behavioral information for a recommendation for improving the behavior, wherein the search is performed by the processor; and 4) the computer system provides the recommendation to the subject.

### Embodiment 3

The system of Embodiment 1, further comprising wherein: 3) the computer system searches a database comprising information that correlates the behavior with a level of acceptability, wherein the search is performed by the processor; 4) categorizing the behavior with a score, wherein the score relates to the acceptability of the behavior; and 5) the computer system provides the score to the subject.

### Embodiment 4

The system of Embodiment 1, further comprising wherein the computer system receives information manually reported by a user.

### Embodiment 5

The system of any one of Embodiments 1-4, wherein the environment is the subject's home.

### Embodiment 6

The system of any one of Embodiments 1-5, wherein the subject is human.

### Embodiment 7

The system of any one of Embodiments 1-5, wherein the subject is not-human.

### Embodiment 8

The system of any one of Embodiments 1-7, wherein the first sensor is associated with the subject's body.

### Embodiment 9

The system of any one of Embodiments 1-8, wherein the second sensor is not associated with the subject's body.

### Embodiment 10

The system of any one of Embodiments 1-9, wherein the first sensor is worn on the subject's body or clothing.

### Embodiment 11

The system of any one of Embodiments 1-9, wherein the first sensor is suitable for ingestion into the subject's body.

### Embodiment 12

The system of any one of Embodiments 1-9, wherein the first sensor is implanted into the subject's body.

### Embodiment 13

The system of any one of Embodiments 1-12, wherein the subject is unaware of the behavior.

### Embodiment 14

A method comprising: a) monitoring the subject with a first sensor to detect the behavior, wherein the first sensor transmits a first signal to a computer system upon detecting the behavior; b) monitoring the subject with a second sensor to detect the behavior, where the second sensor transmits a second signal to the computer system upon detecting the behavior; and c) confirming by the computer system that the behavior occurred by a comparison of the first signal and the second signal, wherein the comparison is performed by a processor.

### Embodiment 15

The method of Embodiment 14, further comprising: d) identifying the behavior by the computer system based on a relationship between the first sensor and the second sensor.

### Embodiment 16

The method of any one of Embodiments 13-15, wherein the relationship is spatial.

### Embodiment 17

The method of any one of Embodiments 13-16, wherein the relationship is functional.

### Embodiment 18

The method of any one of Embodiments 13-17, further comprising: e) searching by the computer system a database comprising behavioral information for a recommendation for improving the behavior, wherein the computer system performs the search by the processor; and f) providing the recommendation to a user.

### Embodiment 19

The method of any one of Embodiments 13-18, further comprising receiving by the computer system a manually reported identification of the behavior by a user.

### Embodiment 20

The method of any one of Embodiments 13-19, wherein the behavior occurs in the subject's home.

### Embodiment 21

The method of any one of Embodiments 13-20, wherein the subject is human.

### Embodiment 22

The method of any one of Embodiments 13-20, wherein the subject is not-human.

### Embodiment 23

The method of any one of Embodiments 13-22, wherein the first sensor is associated with the subject's body.

### Embodiment 24

The method of any one of Embodiments 13-23, wherein the second sensor is not associated with the subject's body.

### Embodiment 25

The method of any one of Embodiments 13-24, wherein the first sensor is worn on the subject's body or clothing.

### Embodiment 26

The method of any one of Embodiments 13-24, wherein the first sensor is suitable for ingestion into the subject's body.

### Embodiment 27

The method of any one of Embodiments 13-24, wherein the first sensor is implanted into the subject's body.

### Embodiment 28

The method of any one of Embodiments 13-27, wherein the subject is unaware of the behavior.

### Embodiment 29

The method of any one of Embodiments 1-28, wherein at least one additional sensor is in communication with the receiver.

### Embodiment 30

A computer program product comprising a computer-readable medium having computer-executable code encoded therein, the computer-executable code adapted to be executed to implement a method for improving a behavior in a subject, the method comprising: a) providing a behavioral change system, wherein the behavioral change system comprises: i) a database, wherein the database comprises behavioral information and recommendations for improving behaviors; ii) a signal detection module; iii) a search module; iv) a behavior interpretation module; and v) a behavioral change output module; b) detecting a signal by the signal detection module, whereupon the signal detection module instructs the search module to search the database for a recommendation for improving the behavior; c) searching the database by the search module, wherein the search module searches the database for the recommendation thereby identifying a potential recommendation for improving the behavior, and transmits the potential recommendation to the behavior interpretation module; d) interpreting the behavior by the behavior interpretation module; wherein the interpreting the behavior comprises associating the behavior with the potential recommendation to identify a relevant recommendation; and e) outputting the relevant recommendation via the output module.

### Embodiment 31

The computer program product of Embodiment 30, wherein the behavioral change system further comprises a scoring module, wherein: the scoring module categorizes the behavior with a score, wherein the score relates to an acceptability of the behavior.

### Embodiment 32

The computer program product of Embodiment 30, wherein the detecting the behavior by the signal detection module comprises receiving the signal from a sensor associated with the subject, wherein the sensor transmits the signal to the signal detection module upon detecting the behavior by the sensor.

### Embodiment 33

The computer program product of any one of Embodiments 30-32, wherein the interpreting of the behavior creates a medical record data point.

### Embodiment 34

The computer program product of any one of Embodiments 30-32, wherein the interpreting of the behavior identifies a previously uncharacterized aspect of the behavior.

### Embodiment 35

The computer program product of any one of Embodiments 30-32, wherein the interpreting of the behavior provides an association of a biometric marker with the behavior.

### Embodiment 36

The computer program product of any one of Embodiments 28-33, further comprising a receiving module, wherein the receiving module receives an identification of the behavior by a user and confirms the behavior by a comparison of the identification and the detected signal.

### Embodiment 37

A system for sensing a factor associated with a behavior of a subject in an environment, the system comprising: a) a first sensor, wherein the first sensor is in the environment, and wherein the first sensor detects a first factor associated with the behavior, whereupon the first sensor modifies the first factor, whereupon the first sensor physically transmits a second factor into the environment; b) a second sensor, wherein the second sensor detects the second factor, whereupon detecting the second factor the second sensor transmits an indication that the factor associated with the behavior has been detected.

### Embodiment 38

The system of Embodiment 37, wherein the environment is the subject's body.

### Embodiment 39

The system of any one of Embodiments 37-38, wherein the first sensor modifies the first factor.

### Embodiment 40

The system of any one of Embodiments 37-39, wherein the second sensor modifies the second factor.

### Embodiment 41

The system of any one of Embodiments 37-40, wherein the first sensor detects the first factor in a fluid of the subject's body.

### Embodiment 42

The system of any one of Embodiments 37-41, wherein the first sensor is worn on the subject's body or clothing.

### Embodiment 43

The system of any one of Embodiments 37-41, wherein the first sensor is suitable for ingestion into the subject's body.

### Embodiment 44

The system of any one of Embodiments 37-43, wherein at least one additional sensor transmits an additional indication that the behavior has occurred.

### Embodiment 45

The system of any one of Embodiments 37-44, further comprising a computer system comprising a processor, wherein the processor archives at least one detected signal.

### Embodiment 46

The system of Embodiment 45, wherein the computer system transmits at least one detected signal to a receiver.

### Embodiment 47

A method for detecting a factor associated with an occurrence of a behavior of a subject, the method comprising: a) monitoring the subject with a first sensor to detect the factor associated with the behavior, whereupon the first sensor physically transmits a signal into an environment; and b) monitoring, by at least one additional sensor, the environment for the presence of the signal, whereupon detecting the signal by at least one additional sensor triggers a transmittal of an indication that the behavior has occurred.

### Embodiment 48

The method of Embodiment 47, wherein the first sensor detects a factor in a fluid of the subject's body.

### Embodiment 49

The method of any one of Embodiments 47-48, wherein the first sensor modifies the factor.

### Embodiment 50

The method of any one of Embodiments 47-49, wherein at least one additional sensor modifies the factor.

### Embodiment 51

The method of any one of Embodiments 47-50, wherein the first sensor is worn on the subject's body or clothing.

### Embodiment 52

The method of any one of Embodiments 47-50, wherein the first sensor is suitable for ingestion into the subject's body.

### Embodiment 53

The method of any one of Embodiments 47-52, wherein at least one additional sensor transmits to the subject an indication that the behavior has occurred.

### Embodiment 54

The method of any one of Embodiments 47-53, further comprising wherein a computer system comprising a processor, receives at least one signal sensed by at least one of the sensors.

### Embodiment 55

The method of Embodiment 54 wherein the computer system transmits at least one signal sensed by at least one of the sensors to a receiver.

What is claimed is:

1. A system for sensing a behavior of a subject in an environment, the system comprising:
a) a receiver;
b) a first sensor in communication with the receiver, wherein the first sensor is in the environment, and wherein the first sensor detects the behavior and transmits a first signal associated with the behavior to the receiver, whereupon the receiver receives the first signal;
c) a second sensor in communication with the receiver, wherein the second sensor is in the environment, and wherein the second sensor detects the behavior and transmits a second signal associated with the behavior to the receiver, whereupon the receiver receives the second signal; and
d) a computer system comprising a processor,
wherein:
1) the receiver sends the first and second signals to the computer system; and
2) the computer system compares, by the processor, the first and second signals to confirm that the behavior occurred.

2. The system of claim 1, further comprising wherein:
3) the computer system searches a database comprising behavioral information for a recommendation for improving the behavior, wherein the search is performed by the processor; and
4) the computer system provides the recommendation to the subject.

3. The system of claim 1, further comprising wherein:
3) the computer system searches a database comprising information that correlates the behavior with a level of acceptability, wherein the search is performed by the processor;
4) categorizing the behavior with a score, wherein the score relates to the acceptability of the behavior; and
5) the computer system provides the score to the subject.

4. The system of claim 1, further comprising wherein the computer system receives information manually reported by a user.

5. The system of claim 1, wherein the environment is the subject's home.

6. The system of claim 1, wherein the subject is human.

7. The system of claim 1, wherein the subject is not-human.

8. The system of claim 1, wherein the first sensor is associated with the subject's body.

9. The system of claim 8, wherein the second sensor is not associated with the subject's body.

10. The system of claim 8, wherein the first sensor is worn on the subject's body or clothing.

11. The system of claim 8, wherein the first sensor is suitable for ingestion into the subject's body.

12. The system of claim 8, wherein the first sensor is implanted into the subject's body.

13. The system of claim 1, wherein the subject is unaware of the behavior.

14. A method for detecting an occurrence of a behavior of a subject, the method comprising:
a) monitoring the subject with a first sensor to detect the behavior, wherein the first sensor transmits a first signal to a computer system upon detecting the behavior;
b) monitoring the subject with a second sensor to detect the behavior, where the second sensor transmits a second signal to the computer system upon detecting the behavior; and
c) confirming by the computer system that the behavior occurred by a comparison of the first signal and the second signal, wherein the comparison is performed by a processor.

15. The method of claim 14, further comprising:
d) identifying the behavior by the computer system based on a relationship between the first sensor and the second sensor.

16. The method of claim 15, wherein the relationship is spatial.

17. The method of claim 15, wherein the relationship is functional.

18. The method of claim 15, further comprising:
e) searching by the computer system a database comprising behavioral information for a recommendation for improving the behavior, wherein the computer system performs the search by the processor; and
f) providing the recommendation to a user.

19. The method of claim 14, further comprising receiving by the computer system a manually reported identification of the behavior by a user.

20. The method of claim 14, wherein the behavior occurs in the subject's home.

21. The method of claim 14, wherein the subject is human.

22. The method of claim 14, wherein the subject is not-human.

23. The method of claim 14, wherein the first sensor is associated with the subject's body.

24. The method of claim 23, wherein the second sensor is not associated with the subject's body.

25. The method of claim 23, wherein the first sensor is worn on the subject's body or clothing.

26. The method of claim 23, wherein the first sensor is suitable for ingestion into the subject's body.

27. The method of claim 14, wherein the first sensor is implanted into the subject's body.

28. The method of claim 14, wherein the subject is unaware of the behavior.

29. The method of claim 14, wherein at least one additional sensor is in communication with the receiver.

30. A computer program product comprising a computer-readable medium having computer-executable code encoded therein, the computer-executable code adapted to be executed to implement a method for improving a behavior in a subject, the method comprising:
a) providing a behavioral change system, wherein the behavioral change system comprises:
i) a database, wherein the database comprises behavioral information and recommendations for improving behaviors;
ii) a signal detection module;
iii) a search module;
iv) a behavior interpretation module; and
v) a behavioral change output module;
b) detecting a signal by the signal detection module, whereupon the signal detection module instructs the search module to search the database for a recommendation for improving the behavior;
c) searching the database by the search module, wherein the search module searches the database for the recommendation for improving the behavior, thereby identifying a potential recommendation and transmits the potential recommendation to the behavior interpretation module;
d) interpreting the behavior by the behavior interpretation module; wherein the interpreting the behavior comprises associating the behavior with the potential recommendation to identify a relevant recommendation; and
e) outputting the relevant recommendation via the output module.

31. The computer program product of claim 30, wherein the behavioral change system further comprises a scoring module, wherein:
the scoring module categorizes the behavior with a score, wherein the score relates to an acceptability of the behavior.

32. The computer program product of claim 30, wherein the detecting the behavior by the signal detection module comprises receiving the signal from a sensor associated with the subject, wherein the sensor transmits the signal to the signal detection module upon detecting the behavior by the sensor.

33. The computer program product of claim 30, wherein the interpreting of the behavior creates a medical record data point.

34. The computer program product of claim 30, wherein the interpreting of the behavior identifies a previously uncharacterized aspect of the behavior.

35. The computer program product of claim 30, wherein the interpreting of the behavior provides an association of a biometric marker with the behavior.

36. The computer program product of claim 30, further comprising a receiving module, wherein the receiving module receives an identification of the behavior by a user and confirms the behavior by a comparison of the identification and the detected signal.

37. A system for sensing a factor associated with a behavior of a subject in an environment, the system comprising:
a) a first sensor, wherein the first sensor is in the environment, and wherein the first sensor detects a first factor associated with the behavior, whereupon the first sensor modifies the first factor, whereupon the first sensor physically transmits a second factor into the environment;
b) a second sensor, wherein the second sensor detects the second factor, whereupon detecting the second factor the second sensor transmits an indication that the factor associated with the behavior has been detected.

38. The system of claim 37, wherein the environment is the subject's body.

39. The system of claim 37, wherein the first sensor modifies the first factor.

40. The system of claim 37, wherein the second sensor modifies the second factor.

41. The system of claim 37, wherein the first sensor detects the first factor in a fluid of the subject's body.

42. The system of claim 37, wherein the first sensor is worn on the subject's body or clothing.

43. The system of claim 37, wherein the first sensor is suitable for ingestion into the subject's body.

44. The system of claim 37, wherein at least one additional sensor transmits an additional indication that the behavior has occurred.

45. The system of claim 37, further comprising a computer system comprising a processor, wherein the processor archives at least one detected signal.

46. The system of claim 45, wherein the computer system transmits at least one detected signal to a receiver.

47. A method for detecting a factor associated with an occurrence of a behavior of a subject, the method comprising:
a) monitoring the subject with a first sensor to detect the factor associated with the behavior, whereupon the first sensor physically transmits a signal into an environment; and
b) monitoring, by at least one additional sensor, the environment for the presence of the signal, whereupon detecting the signal by at least one additional sensor triggers a transmittal of an indication that the behavior has occurred.

48. The method of claim 47, wherein the first sensor detects a factor in a fluid of the subject's body.

49. The method of claim 47, wherein the first sensor modifies the factor.

50. The method of claim 47, wherein at least one additional sensor modifies the factor.

51. The method of claim 47, wherein the first sensor is worn on the subject's body or clothing.

52. The method of claim 47, wherein the first sensor is suitable for ingestion into the subject's body.

53. The method of claim 47, wherein at least one additional sensor transmits to the subject an indication that the behavior has occurred.

54. The method of claim 47, further comprising wherein a computer system comprising a processor, receives at least one signal sensed by at least one of the sensors.

55. The method of claim 54 wherein the computer system transmits at least one signal sensed by at least one of the sensors to a receiver.
